(19) United States
(12) Patent Application Publication
(10) Pub. No.: US 2026/0264243 A1
(43) Pub. Date: Sep. 10, 2026

(54) ROBOT CONTROL DEVICE, ROBOT SYSTEM, AND ROBOT CONTROL METHOD

(71) Applicant: Fanuc Corporation, Minamitsuru-gun, Yamanashi (JP)

(72) Inventors: Yasuhiro NAITOU, Minamitsuru-gun, Yamanashi (JP); Shintarou HORI, Minamitsuru-gun, Yamanashi (JP)

(73) Assignee: Fanuc Corporation, Minamitsuru-gun, Yamanashi (JP)

(21) Appl. No.: 18/876,780

(22) PCT Filed: Jun. 30, 2022
(86) PCT No.: PCT/JP2022/026381

§ 371 Date: Dec. 19, 2024

(51) Int. Cl. B25J 9/16

(52) U.S. Cl. CPC B25J 9/1676; B25J 9/1694

(57) ABSTRACT

A control device includes: a safety function execution unit that monitors at least one of contact force applied to a robot in operation, a speed of the robot, and an acceleration of the robot, and that executes a safety function for stopping the operation of the robot if the at least one has exceeded a prescribed threshold value; and a direct teaching execution unit that executes a direct teaching function for causing the robot to operate in accordance with operation force applied to the robot, concurrently with the safety function executed by the safety function execution unit.

### CROSS REFERENCE TO RELATED APPLICATIONS

This is the U.S. National Phase application of PCT/JP2022/026381, filed Jun. 30, 2022 the disclosure of this application being incorporated herein by reference in its entirety for all purposes.

### FIELD OF THE INVENTION

The present disclosure relates to a robot controller, a robot system, and a robot control method.

### BACKGROUND OF THE INVENTION

A direct teach function is known with which an external force is applied to a robot and the robot is operated in accordance with the external force (e.g., Patent Literature 1).

### Patent Literature

PTL 1: JP 2015-182142 A

### SUMMARY OF THE INVENTION

In the related art, ensuring the safety of an operator is desired when executing the direct teach function.

A controller configured to control an operation of a robot according to an aspect of the present disclosure includes: a safety function execution unit configured to execute a safety function of monitoring at least one of a contact force applied to the robot in operation, a speed of the robot, and an acceleration of the robot, and stopping the operation of the robot when the at least one of the contact force, the speed, and the acceleration exceeds a predetermined threshold value; and a direct teach execution unit configured to execute a direct teach function of operating the robot in accordance with a handling force applied to the robot, in parallel with the safety function executed by the safety function execution unit.

A controller configured to control an operation of a robot according to another aspect of the present disclosure includes: a direct teach execution unit configured to execute a direct teach function of operating the robot in accordance with a handling force applied to the robot; an operation parameter acquisition unit configured to acquire a speed or an acceleration of the robot during execution of the direct teach function; and a resistance force control unit configured to change a resistance force against the handling force in response to the speed or the acceleration acquired by the operation parameter acquisition unit.

A controller configured to control an operation of a robot according to still another aspect of the present disclosure includes a direct teach execution unit configured to execute a direct teach function of operating the robot in accordance with a handling force applied to the robot, wherein the direct teach execution unit ends the direct teach function when an elapsed time exceeds a predetermined threshold value, the elapsed time being from a time point at which the direct teach execution unit receives a command for starting the direct teach function, a time point at which the direct teach execution unit starts the direct teach function, or a time point at which the robot operated under the direct teach function is stopped.

A controller configured to control an operation of a robot according to yet still another aspect of the present disclosure includes a direct teach execution unit configured to execute a direct teach function of operating the robot in accordance with a handling force applied to the robot, wherein, after the direct teach execution unit receives a command for executing the direct teach function and starts the direct teach function, the direct teach execution unit continuously executes the direct teach function without receiving the command again.

A controller configured to control an operation of a robot according to yet still another aspect of the present disclosure includes: a safety function execution unit configured to execute a safety function of monitoring at least one of a contact force applied to the robot in operation, a speed of the robot, and an acceleration of the robot, and stopping the operation of the robot when the at least one of the contact force, the speed, and the acceleration exceeds a predetermined threshold value; and a direct teach execution unit configured to execute a direct teach function of operating the robot in accordance with a handling force applied to the robot. The robot is provided with a force sensor configured to detect an external force applied to the robot. The safety function execution unit and the direct teach execution unit execute the safety function and the direct teach function respectively, based on detection data from the force sensor commonly used.

A method of controlling an operation of a robot according to yet still another aspect of the present disclosure includes: executing by a processor, a safety function of monitoring at least one of a contact force applied to the robot in operation, a speed of the robot, and an acceleration of the robot, and stopping the operation of the robot when the at least one of the contact force, the speed, and the acceleration exceeds a predetermined threshold value; and executing, by the processor, a direct teach function of operating the robot in accordance with a handling force applied to the robot, in parallel with the safety function.

A method of controlling an operation of a robot according to yet still another aspect of the present disclosure includes: executing by a processor, a direct teach function of operating the robot in accordance with a handling force applied to the robot; acquiring by the processor, a speed or an acceleration of the robot during execution of the direct teach function; and changing by the processor, a resistance force against the handling force in response to the speed or the acceleration acquired.

A method of controlling an operation of a robot according to still another aspect of the present disclosure includes: executing by a processor, a direct teach function of operating the robot in accordance with a handling force applied to the robot; and ending, by the processor, the direct teach function when an elapsed time exceeds a predetermined threshold value, the elapsed time being from a time point at which the direct teach execution unit receives a command for starting the direct teach function, a time point at which the direct teach execution unit starts the direct teach function, or a time point at which the robot operated under the direct teach function is stopped.

### BRIEF DESCRIPTION OF THE DRAWINGS

FIG. 1 is a schematic view of a robot system according to an embodiment.

FIG. 2 is a block diagram of the robot system illustrated in FIG. 1.

FIG. 3 is a flowchart illustrating an example of an operation flow of the robot system illustrated in FIG. 2.

FIG. 4 illustrates an example of a direct teach image.

FIG. 5 is a flowchart illustrating an example of a flow of step S2 in FIG. 3.

FIG. 6 is a flowchart illustrating an example of the flow of step S3 in FIG. 3.

FIG. 7 is a flowchart illustrating another example of an operation flow of the robot system illustrated in FIG. 2.

FIG. 8 is a flowchart illustrating an example of the flow of step S3′ in FIG. 7.

FIG. 9 is a block diagram illustrating another function of the robot system illustrated in FIG. 2.

FIG. 10 illustrates an example of a safety function setting image.

FIG. 11 is a flowchart illustrating an example of an operation flow of the robot system illustrated in FIG. 9.

FIG. 12 is a flowchart illustrating an example of a flow of step S3 in FIG. 11.

FIG. 13 is a flowchart illustrating an example of a flow of step S2 in FIG. 11.

FIG. 14 is a schematic view of a torque sensor according to an embodiment.

FIG. 15 is a schematic view of a force detection sensor according to an embodiment.

FIG. 16 is a block diagram illustrating a safety function and a direct teach function executed using the force sensor illustrated in FIG. 14 or FIG. 15.

FIG. 17 is a block diagram of a processor that executes the safety function and the direct teach function illustrated in FIG. 16.

FIG. 18 is a flowchart illustrating an example of a flow of a failure detection function.

FIG. 19 is a block diagram illustrating yet another function of the robot system illustrated in FIG. 2.

FIG. 20 is a flowchart illustrating an example of the direct teach function executed by a controller illustrated in FIG. 19.

FIG. 21 is a flowchart illustrating an example of the direct teach function executed by the controller illustrated in FIG. 19.

FIG. 22 illustrates a graph of characteristic data.

FIG. 23 is a flowchart illustrating yet another example of the direct teach function executed by the controller illustrated in FIG. 19.

FIG. 24 is a block diagram illustrating a method of generating a command for an actuator.

FIG. 25 is a block diagram illustrating yet another function of the robot system illustrated in FIG. 2.

FIG. 26 is a flowchart illustrating an example of the direct teach function executed by a controller illustrated in FIG. 25.

FIG. 27 is a flowchart illustrating another example of the direct teach function executed by the controller illustrated in FIG. 25.

FIG. 28 is a block diagram illustrating yet another function of the robot system illustrated in FIG. 2.

### DETAILED DESCRIPTION OF EMBODIMENTS OF THE INVENTION

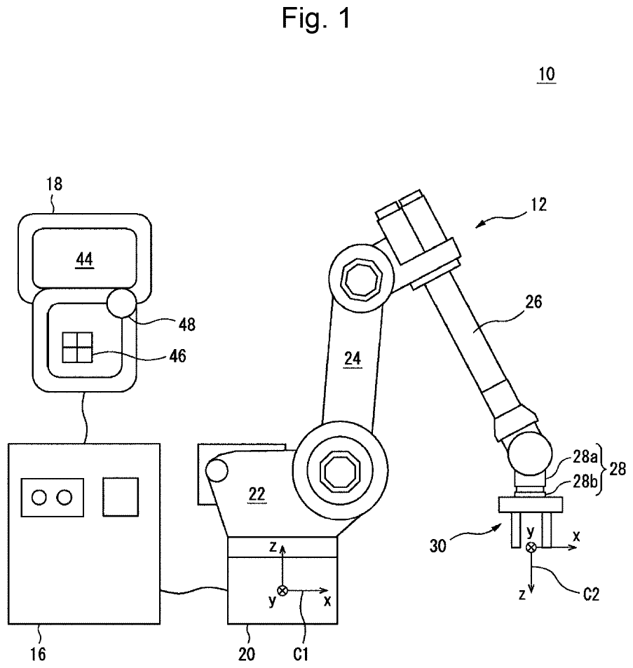

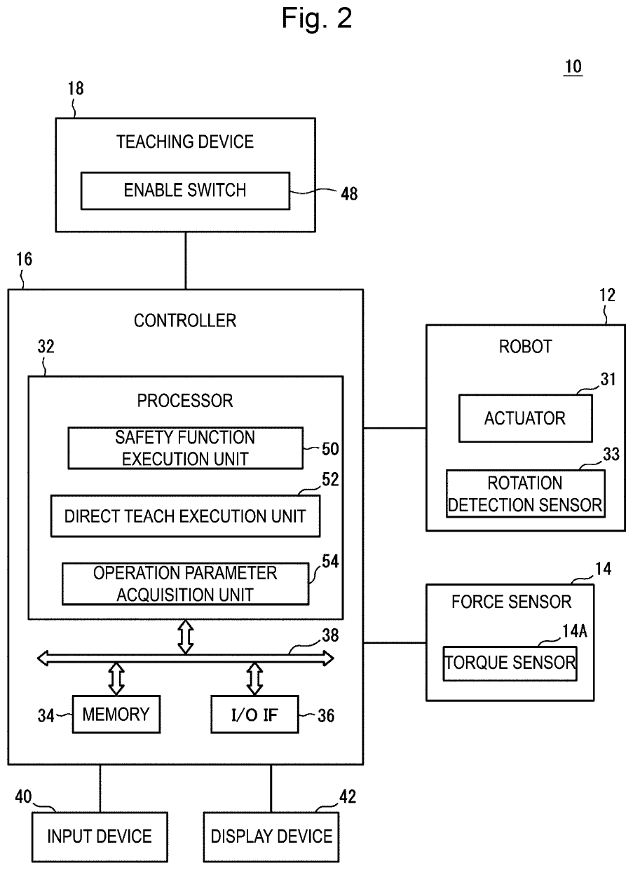

Embodiments of the present disclosure are described in detail below with reference to the drawings. Note that in various embodiments described below, the same elements are denoted with the same reference numerals, and overlapping description is omitted. First, a robot system 10 according to an embodiment will be described with reference to FIG. 1 and FIG. 2. The robot system 10 includes a robot 12, a force sensor 14 (FIG. 2), a controller 16, and a teaching device 18. In the present embodiment, the robot 12 is a vertical articulated robot, which includes a robot base 20, a rotary barrel 22, a lower arm 24, an upper arm 26, a wrist 28, and an end effector 30. The robot base 20 is fixed on the floor of a work cell or on an automatically guided vehicle (AGV).

The rotary barrel 22 is mounted on the robot base 20 to be rotatable about a vertical axis. The lower arm 24 is provided at the rotary barrel 22 so as to be rotatable around the horizontal axis, and the upper arm 26 is rotatably provided at the distal end portion of the lower arm 24. The wrist 28 includes a wrist base 28a provided at a distal end portion of the upper arm 26 so as to be rotatable around two axes perpendicular to each other, and a wrist flange 28b rotatably provided at the wrist base 28a.

The robot base 20, the rotary barrel 22, the lower arm 24, the upper arm 26, and the wrist 28 are provided with a plurality of actuators 31 (FIG. 2). The actuators 31 include servomotors and the like, and rotate each movable component of the robot 12 (i.e., the rotary barrel 22, the lower arm 24, the upper arm 26, the wrist 28, and the wrist flange 28b) in response to a command from the controller 16, thereby moving the end effector 30.

Each actuator 31 is provided with a rotation detection sensor 33. The rotation detection sensor 33 includes, for example, an encoder or a Hall effect device, and detects a rotational position (or a rotational angle) of an output shaft 31a of the actuator 31 (specifically, servomotor). The rotation detection sensor 33 supplies detection data of the detected rotational position to the controller 16 as feedback FB.

The end effector 30 is detachably attached to the wrist flange 28b. The end effector 30 is a robot hand, a welding gun, a laser machining head, a cutting tool, or the like for example, and performs a predetermined work (workpiece handling, welding, laser machining, cutting process, or the like) on a workpiece (not illustrated).

The force sensor 14 detects an external force F applied to the robot 12. In the present embodiment, the force sensor 14 includes a plurality of torque sensors 14A provided to the output shafts 31a of the respective actuators 31. Each of the torque sensors 14A includes at least one sensor device (e.g., a strain gauge or a piezoelectric device), and detects a torque τ applied to the output shaft 31a of the corresponding one of the actuators 31 (servomotors) as a force component of the external force F. The torque sensors 14A each supply detection data DDτ of the detected torque τ to the controller 16.

The controller 16 controls an operation of the robot 12. As illustrated in FIG. 2, the controller 16 is a computer with a processor 32, a memory 34, and an I/O interface 36. The processor 32 includes a CPU, a GPU, or the like, and is communicably connected to the memory 34 and the I/O interface 36 via a bus 38.

The processor 32 executes calculation processing for executing various functions FN of the robot 12 such as a safety function FN1 and a direct teach function FN2 described below, while communicating with the memory 34 and the I/O interface 36. Specifically, in order to execute the function FN of the robot 12, the processor 32 generates a command (e.g., a position command, a speed command, or a torque command) to each actuator 31 (servomotor) and drives each actuator 31 in accordance with the command. Thus, the robot 12 can position the end effector 30 at a desired position. In the present description, “position” may indicate a position and an orientation.

The memory 34 includes a RAM, a ROM, and the like and temporarily or permanently stores various types of data. The memory 34 may be a computer readable recording medium such as a semiconductor memory, a magnetic recording medium, or an optical recording medium. The I/O interface 36 includes, for example, an Ethernet (trade name) port, a USB port, an optical fiber connector, or an HDMI (trade name) terminal and communicates data with external devices by wire or wirelessly based on a command from the processor 32. The force sensor 14 (torque sensors 14A), the teaching device 18, and the actuators 31 described above are connected to the I/O interface 36 to be capable of performing wired or wireless communications.

The controller 16 is provided with an input device 40 and a display device 42. The input device 40 includes a push button, a switch, a keyboard, a mouse, a touchscreen, or the like and receives data input from an operator. The display device 42 includes a liquid crystal display, an organic EL display, or the like and visibly displays various types of data through a command from the processor 32.

The display device 42 and the input device 40 are communicably connected to the I/O interface 36. Note that the display device 42 and the input device 40 may be integrally incorporated in a housing of the controller 16, or may be externally attached to the housing as one computer (such as a PC) that is a body separate from the housing of the controller 16.

The teaching device 18 is a computer such as a teach pendant or a tablet terminal device, and teaches an operation to the robot 12. Specifically, the teaching device 18 includes a processor (not illustrated), a memory (not illustrated), a display device 44, and an input device 46, and an enable switch 48. The display device 44 includes a liquid crystal display, an organic EL display, or the like and displays various types of data. The input device 46 includes a push button, a switch, a touchscreen, or the like and receives data input from an operator.

The operator operates the input device 46 to execute various functions FN of the robot 12 such as a teach function FN3, an automatic operation function FN4, and an operation confirmation function FN5. The teach function FN3 is a function FN for teaching the robot 12 an operation for work (workpiece handling, welding, laser machining, cutting process, or the like).

During execution of the teach function FN3, the operator operates the input device 46 to implement a jog operation of the robot 12 via the controller 16, and thus can position the end effector 30 at a desired taught position TP. The processor of the teaching device 18 acquires teach data such as the taught position TP and a speed V at which the end effector 30 is moved to the taught position TP, and generates, based on the teach data, an operation program PG1 in which the taught position TP and the speed V are defined as instruction codes. The processor 32 of the controller 16 acquires the operation program PG1 generated from the teaching device 18 and stores the operation program PG1 in the memory 34.

On the other hand, the automatic operation function FN4 is a function FN for automatically operating the robot 12 in accordance with the generated operation program PG1, to perform work on a workpiece. The operator operates the input device 46 to cause the processor 32 of the controller 16 to start the automatic operation function FN4. After the processor 32 starts the automatic operation function FN4, the processor 32 generates commands for the actuators 31 in accordance with the operation program PG1 stored in the memory 34, and automatically operates the robot 12 to perform work on the workpiece.

In the automatic operation function FN4, the robot 12 and the operator may cooperation with each other to execute part of the work. Specifically, the processor 32 may execute the direct teach function FN2, which will be described below, for a part of the work, and may operate the robot 12 in response to a handling force Fh applied to the robot 12 by the operator.

The operation confirmation function FN5 is a function FN for causing the robot 12 to perform a trial operation to confirm the operation taught to the robot 12 by the teach function FN3. The operator can operate the input device 46 to cause the processor 32 of the controller 16 to execute the operation confirmation function FN5.

After the processor 32 starts the operation confirmation function FN5, the processor 32 causes the robot 12 to execute an uncompleted operation program PG1′ generated while the teaching by the teach function FN3 described above is in progress, on a trial basis. Accordingly, the operator confirms the operation taught to the robot 12 (i.e., the suitability of the operation program PG1′).

The controller 16 or the teaching device 18 may be provided with a switch SW (not illustrated) for switching the function FN of the robot 12 described above among the teach function FN3, the automatic operation function FN4, and the operation confirmation function FN5. The switch SW may be a physical switch or a software-based virtual switch displayed as an image on the display device 42 or 44.

The enable switch 48 is a physical switch that enables the operator to manually operate the robot 12. Specifically, the enable switch 48 can be switched among an initial position P0, a first pressed position P1 as a result of pressing by a predetermined pressing amount from the initial position P0, and a second pressed position P2 as a result of pressing by a predetermined pressing amount from the first pressed position P1.

When the operator presses the enable switch 48 to the first pressed position P1, the enable switch 48 is turned ON. As a result, the processor of the teaching device 18 is in a state capable of executing the above-described teach function FN3 or another direct teach function FN2′ to be described below. Thus, the robot 12 can be operated via the controller 16.

On the other hand, when the enable switch 48 returns to the initial position P0 or is further pressed to the second pressed position P2 during the operation of the robot 12, the enable switch 48 is turned OFF, and the processor of the teaching device 18 transmits an enable switch OFF signal to the controller 16. Upon receiving the enable switch OFF signal, the processor 32 of the controller 16 executes an emergency stop operation ES.

As an example of the emergency stop operation ES, the processor 32 stops the operation of the robot 12 by stopping the command (a torque command or the like) to each actuator 31. As another example of the emergency stop operation ES, the processor 32 forcibly stops the operation of the robot 12 by actuating a brake mechanism (not illustrated) that brakes the output shaft of each actuator 31.

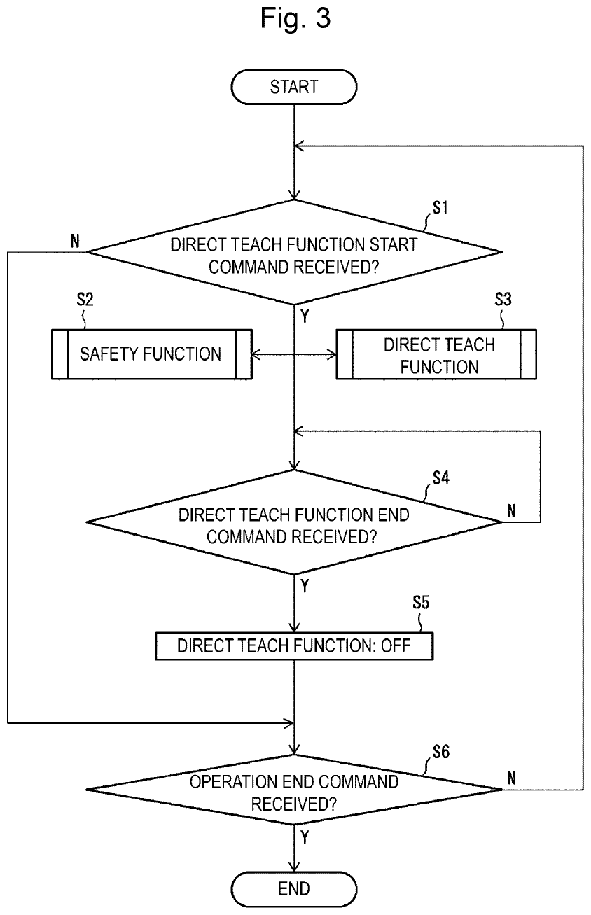

Next, an example of the operation flow of the robot system 10 will be described with reference to FIG. 3. A flow illustrated in FIG. 3 starts when the processor 32 of the controller 16 receives an operation start command (e.g., power ON command) from the operator (i.e., the input device 40 or 46), a host controller, or a computer program PG2.

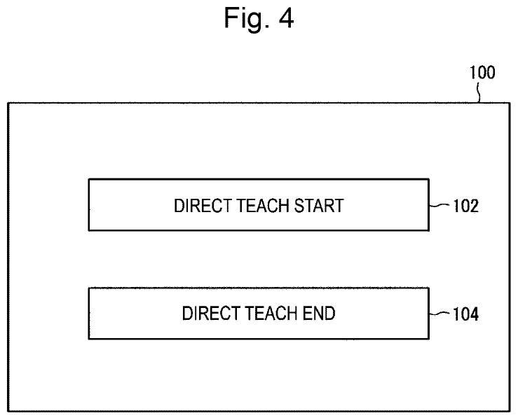

In step S1, the processor 32 determines whether or not the controller 16 has received a direct teach function start command. Specifically, the processor of the teaching device 18 generates a direct teach image 100 for inputting the direct teach function start command and displays the direct teach image 100 on the display device 44 of the teaching device 18. An example of the direct teach image 100 is illustrated in FIG. 4.

In the example illustrated in FIG. 4, the direct teach image 100 includes a direct teach start button image 102 and a direct teach end button image 104. The operator can select the direct teach start button image 102 or the direct teach end button image 104 by operating the input device 46 to click the direct teach start button image 102 or the direct teach end button image 104 displayed on the direct teach image 100.

Upon receiving an input for selecting the direct teach start button image 102, the processor of the teaching device 18 transmits a direct teach function start command to the controller 16. On the other hand, when the processor of the teaching device 18 receives an input for selecting the direct teach end button image 104, the processor transmits a direct teach function end command to the controller 16. The direct teach function start command may be an ON (or “1”) signal, whereas the direct teach function end command may be an OFF (or “0”) signal.

The processor 32 of the controller 16 determines YES in this step S1 when the controller 16 has received the direct teach function start command, enables the direct teach function FN2 (e.g., sets the direct teach function FN2 to “ON” or sets the execution flag for the direct teach function FN2), starts steps S2 and S3 described below, and proceeds to step S4. When the direct teach function start command is not received, the processor 32 determines NO and proceeds to step S6.

In step S4, the processor 32 determines whether or not the controller 16 has received the direct teach function end command described above. The processor 32 determines YES and proceeds to step S5 upon receiving the direct teach function end command, and repeats step S4 upon determining NO. In step S5, the processor 32 disables the direct teach function FN2 (e.g., the direct teach function FN2 is set to “OFF”, or the execution flag of the direct teach function FN2 is deleted).

In step S6, the processor 32 determines whether or not the controller 16 has received an operation end command (e.g., shutdown command) from the operator (i.e., the input device 40 or 46), the host controller, or the computer program PG2. When the controller has received the operation end command, the processor 32 determines YES, and ends the flow illustrated in FIG. 3. On the other hand, upon determining NO, the processor 32 returns to step S1.

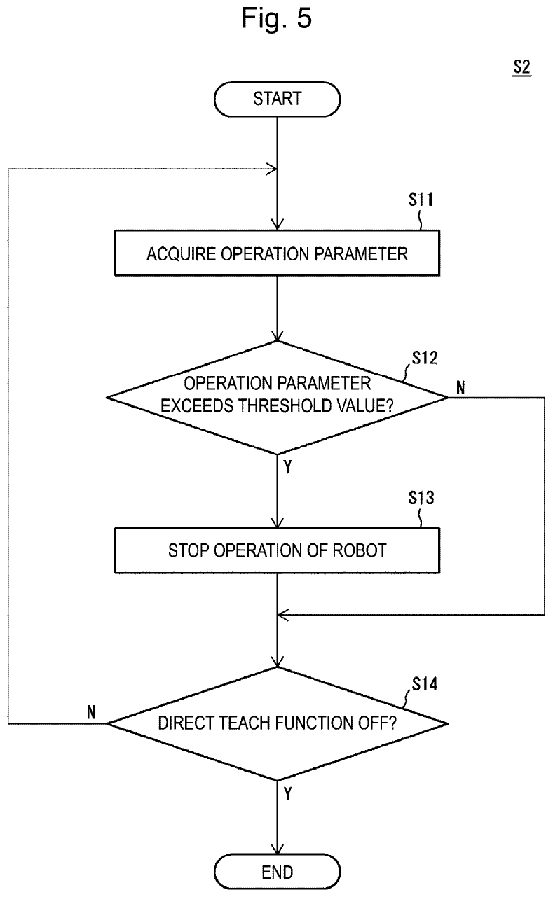

Here, in the present embodiment, upon determining YES in step S1 and enabling the direct teach function FN2, the processor 32 executes the safety function FN1 in step S2 and the direct teach function FN2 in step S3 in parallel. An example of a flow of the safety function FN1 executed in step S2 will be described below with reference to FIG. 5.

In step S11, the processor 32 acquires an operation parameter OP of the robot 12. The operation parameter OP includes at least one of a contact force Fc applied to the robot 12 in operation, the speed V of the robot 12, and an acceleration a of the robot 12. Regarding the contact force Fc, the processor 32 acquires the external force F applied to any part (e.g., the lower arm 24, the upper arm 26, the wrist 28, or the end effector 30) of the robot 12 based on detection data DD of the force sensor 14.

Specifically, the processor 32 acquires the detection data DDτ of each torque sensor 14A and detects the external force F based on the detection data DDτ. The processor 32 can obtain the magnitude of the external force F applied to the robot 12 by executing a predetermined calculation CL1 using the detection data DDτ of each torque sensor 14A. The processor 32 acquires the obtained external force F as the contact force Fc applied to the robot 12 when the robot 12 in operation comes into contact with a surrounding object (an operator, an environmental object, or the like).

Regarding the speed V and the acceleration a, the processor 32 acquires the feedback FB (i.e., the rotational position or the rotational angle of the actuator 31) from the rotation detection sensor 33 provided to each actuator 31. Then, the processor 32 acquires the speed V of the robot 12 (specifically, the end effector 30) by time-differentiating the feedback FB.

Further, the processor 32 acquires the acceleration a of the robot 12 by time-differentiating the speed V. In this way, the processor 32 acquires the at least one of the contact force Fc, the speed V, and the acceleration a as the operation parameter OP. A case where the processor 32 acquires all of the contact force Fc, the speed V, and the acceleration a as the operation parameters OP will be described below.

In step S12, the processor 32 determines whether or not the operation parameter OP (i.e., the contact force Fc, the speed V, and the acceleration a) acquired in the most recent step S11 exceeds a predetermined threshold value. Specifically, the processor 32 determines whether or not the most recently acquired contact force Fc exceeds a predetermined threshold value Fcₜₕ set for the contact force Fc (i.e., Fc≥Fcₜₕ).

The processor 32 determines whether or not the most recently acquired speed V exceeds a predetermined threshold value Vₜₕ for the speed V (i.e., V≥Vₜₕ), and determines whether or not the most recently acquired acceleration a exceeds a predetermined threshold value aₜₕ for the acceleration a (i.e., a≥aₜₕ). The processor 32 determines YES in this step S12 and proceeds to step S13, when Fc≥Fcₜₕ, V≥Vₜₕ, or a≥aₜₕ holds. On the other hand, the processor 32 determines NO and proceeds to step S14, when Fc<Fcₜₕ, V<Vₜₕ, and a<aₜₕ hold.

In step S13, the processor 32 stops the operation of the robot 12. Specifically, the processor 32 implements emergency stop of the operation of the robot 12 by executing the above-described emergency stop operation ES. With this step S13, when the robot 12 collides with the operator (or environmental object), the robot 12 can be stopped, so that the safety of the operator can be guaranteed.

In step S14, the processor 32 determines whether or not the direct teach function FN2 has been disabled in step S5 described above. When the direct teach function FN2 has been disabled, the processor 32 determines YES and ends the safety function FN1 in step S2. On the other hand, the processor 32 determines NO and returns to step S11, when the direct teach function FN2 is enabled.

In this way, the processor 32 monitors the operation parameters OP (the contact force Fc, the speed V, and the acceleration a) by repeatedly executing the loop of steps S14 to S11 until determining YES in step S14, and executes the safety function FN1 of stopping the operation of the robot 12 when the operation parameters OP exceed the threshold values Fcₜₕ, Vₜₕ, and aₜₕ. Thus, the processor 32 functions as a safety function execution unit 50 (FIG. 2) configured to execute the safety function FN1.

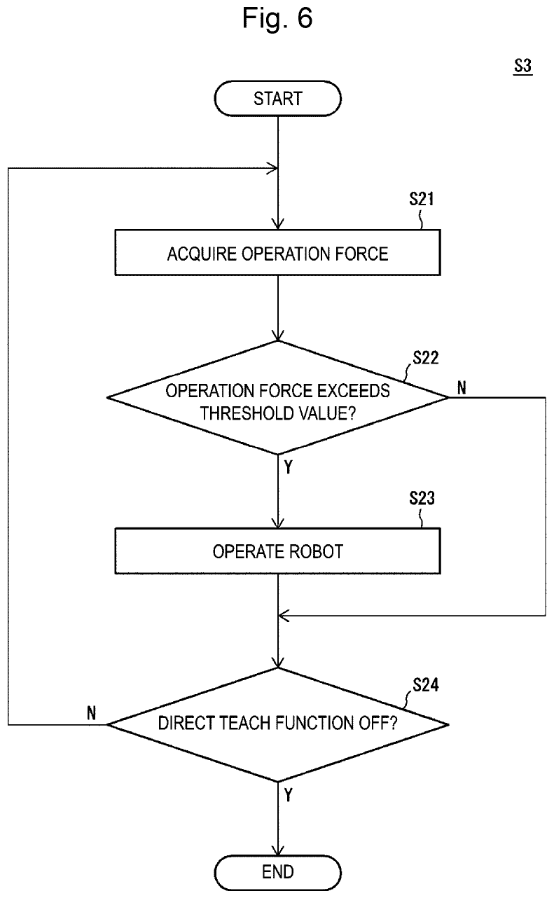

Next, the direct teach function FN2 in step S3 will be described below with reference to FIG. 6. In step S21, the processor 32 acquires the handling force Fh applied to the robot. Specifically, the operator applies the handling force Fh to any part (e.g., the lower arm 24, the upper arm 26, the wrist 28, or the end effector 30) of the robot 12. An operation handle (not illustrated) may be provided to any part of the robot 12 desired to be operated by the operator. In this case, the operator can apply the handling force Fh to any part of the robot 12 by operating the operation handle.

The processor 32 acquires the external force F applied to any part of the robot 12 based on the detection data DD of the force sensor 14. In the present embodiment, the processor 32 acquires the detection data DDτ of each torque sensor 14A and detects the external force F based on the detection data DDτ.

Specifically, the processor 32 can obtain the magnitude and the direction of the external force F applied to the robot 12 by executing a predetermined calculation CL2 using the detection data DDτ of each torque sensor 14A, and can also identify the part of the robot 12 to which the external force F is applied. The processor 32 acquires the obtained external force F as the handling force Fh applied to the robot 12 by the operator.

In step S22, the processor 32 determines whether or not the magnitude of the handling force Fh acquired in the most recent step S21 exceeds a predetermined threshold value Fhₜₕ (i.e., Fh≥Fhₜₕ). The threshold value Fhₜₕ is set to a value smaller than the above-described threshold value Fcₜₕ (Fhₜₕ<Fcₜₕ). The processor 32 proceeds to step S23 upon determining that Fh>Fhₜₕ holds and thus determining YES, and proceeds to step S24 upon determining NO.

In step S23, the processor 32 operates the robot 12 in accordance with the handling force Fh. Specifically, the processor 32 generates a command for moving a part (e.g., the end effector 30) of the robot 12 to which the handling force Fh acquired in the most recent step S21 is applied, in the direction of the handling force Fh, and drives the actuators 31 in accordance with the command. As a result, the robot 12 moves the part to which the operator applies the handling force Fh, in the direction of the handling force Fh.

In this step S23, the processor 32 may move the part of the robot 12 to which the handling force Fh is applied by a predetermined distance d in the direction of the handling force Fh. In this case, when the operator releases the handling force Fh applied to the robot 12 (i.e., releases the hand from the robot 12) after step S23, the robot 12 moves by the predetermined distance d and then automatically stops.

Upon determining YES in step S12 in step S2 (FIG. 5) executed in parallel when operating the robot 12 in this step S23, the processor 32 preferentially executes step S13 in step S2, and stops the robot 12. Thereafter, the processor 32 may not be capable of executing step S12 until determining NO in this step S23 in step S2 (or until a predetermined time elapses).

In step S24, the processor 32 determines whether or not the direct teach function FN2 is disabled in step S5 described above as in step S14 described above. Upon determining YES, the processor 32 ends the direct teach function FN2 in step S3. As a result, the robot 12 stops the operation under the direct teach function FN2. On the other hand, upon determining NO, the processor 32 returns to step S21.

In this way, the processor 32 repeatedly executes the loop of steps S21 to S24 until determining YES in step S24, thereby executing the direct teach function FN2 of operating the robot 12 in accordance with the handling force Fh applied to the robot 12. Therefore, the processor 32 functions as a direct teach execution unit 52 (FIG. 2) that executes the direct teach function FN2.

As described above, in the present embodiment, the processor 32 executes the safety function FN1 in step S2 and the direct teach function FN2 of step S3 in parallel. The processor 32 may execute the loop of steps S11 to S14 in step S2 and the loop of steps S21 to S24 in step S3 in synchronization with each other (or alternately) at a predetermined control interval (e.g., 1 [msec]).

In step S21 in step S3, the processor 32 may obtain the handling force Fh based on the detection data DDτ used to acquire the contact force Fc in step S11 in step S2. Alternatively, in step S21 in step S3, the processor 32 may obtain the handling force Fh based on the detection data DDτ acquired at a time point different from that of the detection data DDτ used to obtain the contact force Fc in step S11 in step S2.

In the present embodiment, the processor 32 acquires the speed V and the acceleration a of the robot 12 at step S3 during execution of the direct teach function FN2 in step S11 in step S2. Therefore, the processor 32 functions as an operation parameter acquisition unit 54 (FIG. 2) that acquires the speed V and the acceleration a during execution of the direct teach function FN2.

As described above, in the present embodiment, the controller 16 includes the safety function execution unit 50 that monitors at least one of the contact force Fc applied to the robot 12 in operation, the speed V of the robot 12, and the acceleration a of the robot 12, and executes the safety function FN1 to stop the operation of the robot 12 when the at least one of the parameters (Fc, V, a) exceeds the predetermined threshold value (Fcₜₕ, Vₜₕ, aₜₕ).

In addition, the controller 16 includes the direct teach execution unit 52 that executes the direct teach function FN2 for operating the robot 12 in accordance with the handling force Fh applied to the robot 12, in parallel with the safety function FN1 executed by the safety function execution unit 50. With this configuration, the direct teach function FN2 can be executed without using the enable switch 48 described above.

More specifically, in the other direct teach function FN2′, from the viewpoint of guaranteeing the safety of the operator, when the processor 32 detects that the operator has turned ON the enable switch 48, the processor 32 disables the safety function FN1 and then executes the direct teach function FN2′.

In the present embodiment, the processor 32 executes the direct teach function FN1 in parallel with the safety function FN2, thereby making it unnecessary to operate the enable switch 48, while guaranteeing the safety of the operator by the safety function FN1 during the execution of the direct teach function FN2. The other direct teach functions FN2′ will be described below.

In the present embodiment, the safety function execution unit 50 and the direct teach execution unit 52 execute each of the safety function FN1 and the direct teach function FN2 respectively, based on the detection data DDτ of the common force sensor 14 (specifically, the torque sensor 14A). With this configuration, both the safety function FN1 and the direct teach function FN2 can be executed with high accuracy.

Further, with the force sensor 14 commonly used between the safety function FN1 and the direct teach function FN2, the cost can be reduced. It is also possible to synchronize the control intervals of the safety function FN1 (specifically, the loop of steps S11 to S14 described above) and the direct teach function FN2 (specifically, the loop of steps S21 to S24 described above) with each other, and to execute the safety function FN1 and the direct teach function FN2 in parallel based on the same (i.e., common) detection data DDτ.

In the present embodiment, a case is described in which in step S11 described above, the processor 32 acquires the contact force Fc and functions as the operation parameter acquisition unit 54 to acquire the speed V and the acceleration a, during execution of the direct teach function FN2. However, the present disclosure is not limited thereto. In step S11 described above, the processor 32 may acquire the contact force Fc but may not acquire the speed V and the acceleration a. In this case, the operation parameter acquisition unit 54 described above can be omitted from the controller 16.

In addition, when the contact force Fc is acquired in step S11 described above, the processor 32 may acquire only the magnitude of the contact force Fc by executing the calculation CL1 different from the calculation CL2 executed in step S21 described above. Alternatively, in step S11, the processor 32 may identify the magnitude and the direction of the contact force Fc as well as the part of the robot 12 to which the contact force Fc is applied by executing the same calculation CL1(=CL2) as the calculation CL2 executed in step S21.

Further, in the present embodiment, a case is described in which the force sensor 14 includes the plurality of torque sensors 14A, and the safety function execution unit 50 and the direct teach execution unit 52 execute the safety function FN1 and the direct teach function FN2 based on the detection data DDτ of the common torque sensor 14A.

However, the present disclosure is not limited thereto, and the force sensor 14 may include the plurality of torque sensors 14A and a force detection sensor 14B capable of detecting forces in six axial directions. The force detection sensor 14B is provided at any part (e.g., the robot base 20) of the robot 12, and can detect the external force F applied to a part of the robot 12 located more on the distal end side than the installation position of the force detection sensor 14B.

In this case, the safety function execution unit 50 may execute the safety function FN1 based on the detection data DDf of the force detection sensor 14B (or the detection data DDτ of the torque sensor 14A), and the direct teach execution unit 52 may execute the direct teach function FN2 based on the detection data DDτ of the torque sensor 14A (or detection data DDf of the force detection sensor 14B).

In the present embodiment, a case is described in which the processor of the teaching device 18 generates the direct teach image 100 and displays it on the display device 44 of the teaching device 18. However, the present disclosure is not limited thereto, and the processor 32 of the controller 16 may generate the direct teach image 100 and display it on the display device 42.

In this case, the operator may operate the input device 40 to select the direct teach start button image 102 or the direct teach end button image 104 in the direct teach image 100 displayed on the display device 42. When the operator selects the direct teach start button image 102, the processor 32 of the controller 16 receives the direct teach function start command through the input device 40.

In the present embodiment, a case is described in which the operator selects the direct teach start button image 102 or the direct teach end button image 104 displayed on the direct teach image 100 to transmit the direct teach function start command or the direct teach function end command to the processor 32.

However, the present disclosure is not limited thereto, and a physical switch (or a physical button) may be provided to the controller 16 or the teaching device 18, and the direct teach function start command or the direct teach function end command may be issued by operating the physical switch. Alternatively, the operator may issue the direct teach function start command or the direct teach function end command to the processor 32 by tapping any part of the robot 12 with his or her hand. The processor 32 can detect the tap operation on the robot 12 by the operator from the detection data DD of the force sensor 14. The enable switch 48 may be provided not only to the teaching device 18 but also to the controller 16 or the like.

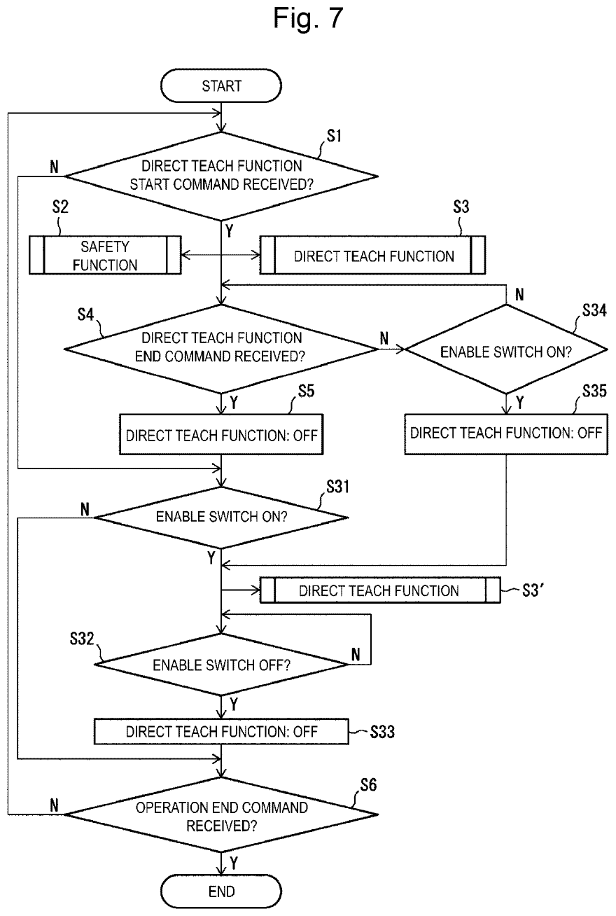

Next, another example of the operation flow of the robot system 10 will be described with reference to FIG. 7. In the flow illustrated in FIG. 7, the processor 32 executes the direct teach function FN2 described above and the other direct teach function FN2′ using the enable switch 48. Note that in the flow illustrated in FIG. 7, the same processing as in the flow of FIG. 3 is denoted by the same step numbers, and redundant descriptions are omitted. Note that, in the flow illustrated in FIG. 7, the processor 32 proceeds to step S31 when determining NO in step S1, or after executing step S5.

In step S31, the processor 32 determines whether or not the enable switch 48 is turned ON (in other words, whether or not the enable switch 48 is pressed to the first pressed position P1). Specifically, when the enable switch 48 is turned ON, the processor of the teaching device 18 transmits an enable switch ON signal to the controller 16. Upon receiving the enable switch ON signal, the processor 32 determines YES, enables the direct teach function FN2′ (sets the direct teach function FN2′ to “ON” or sets the execution flag), starts step S3′ described below, and proceeds to step S32. On the other hand, upon determining NO, the processor 32 proceeds to step S6.

In step S32, the processor 32 determines whether or not the enable switch 48 has been turned OFF (in other words, has returned to the initial position P0 or has been pressed to the second pressed position P2). Specifically, when the enable switch 48 is turned OFF, the processor of the teaching device 18 transmits the enable switch OFF signal to the controller 16. Upon receiving the enable switch OFF signal, the processor 32 of the controller 16 determines YES and proceeds to step S33. On the other hand, upon determining NO, the processor 32 returns to step S32.

In step S33, the processor 32 disables the direct teach function FN2′ (sets the direct teach function FN2′ to “OFF” or deletes the execution flag). Here, in the present embodiment, upon determining YES in step S31 and enabling the direct teach function FN2′, the processor 32 executes the direct teach function FN1′ in step S3′ in a state where the safety function FN1 described above is disabled (i.e., without executing the safety function FN2).

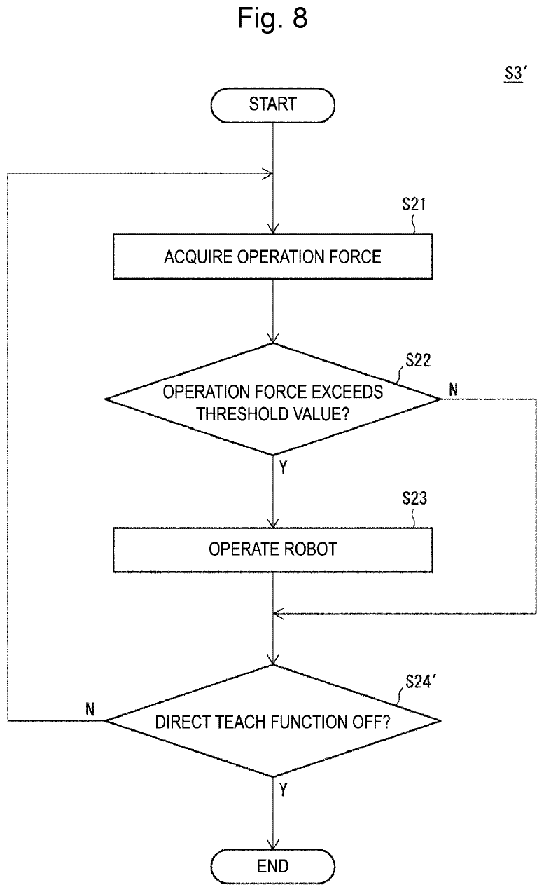

This step S3′ will be described below with reference to FIG. 8. The flow illustrated in FIG. 8 differs from the flow illustrated in FIG. 6 at step S24′. In step S24′, the processor 32 determines whether or not the direct teach function FN2′ has been disabled in step S33 described above. Upon determining YES, the processor 32 executes the above-described emergency stop operation ES to stop the operation of the robot 12 and ends the direct teach function FN2′ in step S3′. On the other hand, upon determining NO, the processor 32 returns to step S21.

As described above, in the other direct teach function FN2′, the processor 32 executes the direct teach function FN2′ while the enable switch 48 is set to be ON by the operator, and ends the direct teach function FN2′ when the enable switch 48 is turned OFF. In other words, in order to execute the other direct teach function FN2′, it is necessary for the operator to set the enable switch 48 to be ON continuously, and continuously provide the enable switch ON signal to the controller 16.

Referring to FIG. 7 again, upon determining NO in step S4, the processor 32 determines in step S34 whether or not the enable switch 48 is turned ON, as in step S31 described above. The processor 32 proceeds to step S35 upon determining YES, and returns to step S4 upon determining NO.

In step S35, as in step S5 described above, the processor 32 disables the direct teach function FN2. As a result, the processor 32 determines YES in step S14 (FIG. 5) and step S24 (FIG. 6) described above, and ends the safety function FN1 in step S2 and the direct teach function FN2 in step S3. On the other hand, the processor 32 enables the direct teach function FN2′, starts step S3′, and proceeds to step S32.

As described above, in the present embodiment, when the enable switch 48 is turned ON during execution of steps S2 and S3 (determined YES in step S34), the processor 32 preferentially executes the other direct teach function FN2′ using the enable switch 48 in step S3′.

With this configuration, the operator can selectively execute the direct teach function FN2 which is executed in parallel with the safety function FN1 without using the enable switch 48 and the other direct teach function FN2′ using the enable switch 48, in response to the application. Thus, the operability of the operator can be improved.

In addition, in the present embodiment, the processor 32 functions as the direct teach execution unit 52, receives a command for executing the direct teach function FN2 in step S3, starts the direct teach function FN2, and then continuously executes the direct teach function FN2 without receiving the command again.

More specifically, upon receiving the direct teach function start command from the operator in step S1 and starting the direct teach function FN2 in step S3, the processor 32 continuously executes the direct teach function FN2 without receiving a further command for executing the direct teach function FN2 (e.g., the direct teach function start command or the enable switch ON signal) again until the processor 32 receives the direct teach function end command in step S4.

In other words, during execution of the direct teach function FN2, the operator does not need to operate the input device 40 or 46 or the enable switch 48 to input any command (e.g., the direct teach function start command or the enable switch ON signal) for continuing the direct teach function FN2.

On the other hand, in the other direct teach function FN2′, as described above, in order to continue the direct teach function FN2′, it is necessary for the operator to continuously turn ON the enable switch 48 and continuously provide the enable switch ON signal to the controller 16. Therefore, according to the direct teach function FN2 in step S3, the operation of the operator can be simplified.

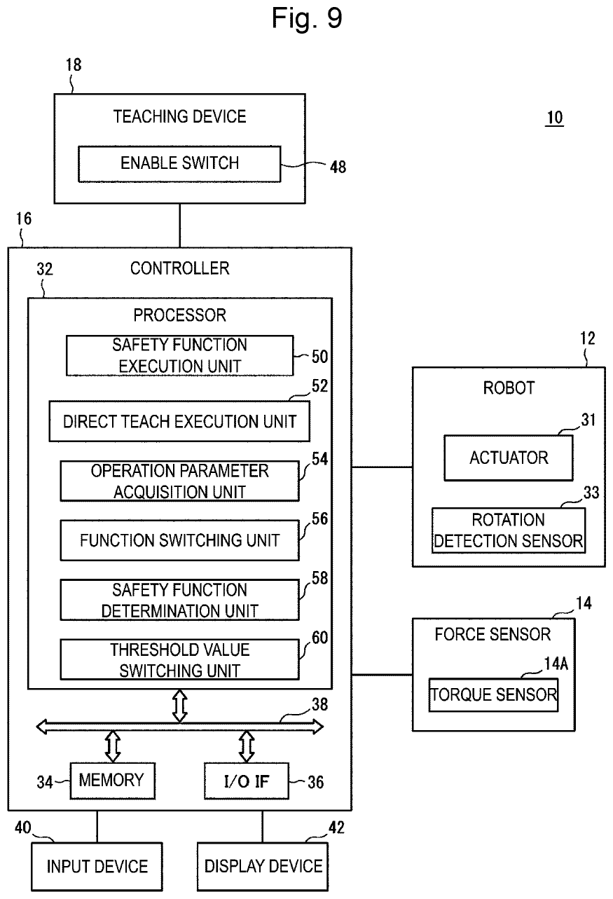

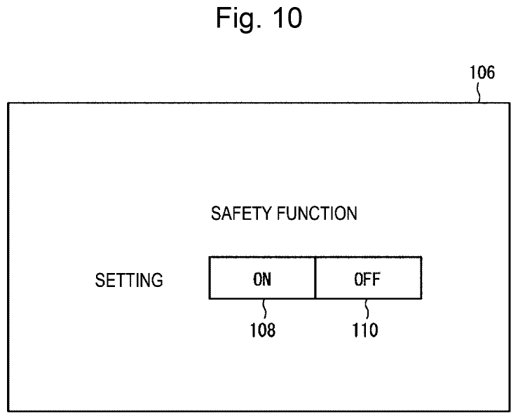

Next, another function of the robot system 10 will be described with reference to FIG. 9. In the present embodiment, the operator can select whether or not to enable or disable the safety function FN1. Specifically, the processor of the teaching device 18 generates a safety function setting image 106 and displays it on the display device 44 of the teaching device 18. An example of the safety function setting image 106 is illustrated in FIG. 10.

In the example illustrated in FIG. 10, the safety function setting image 106 includes an enable button image 108 and a disable button image 110. The operator can select the enable button image 108 or the disable button image 110 by operating the input device 46 to clicking the enable button image 108 or the disable button image 110 displayed on the safety function setting image 106.

The processor of the teaching device 18 transmits a safety function enabling command for enabling the safety function FN1 to the controller 16 upon receiving an input for selecting the enable button image 108, and transmits a safety function disabling command for disabling the safety function FN1 to the controller 16 upon receiving an input for selecting the disable button image 110.

The processor 32 of the controller 16 enables or disables the safety function FN1 in response to the safety function enabling command or the safety function disabling command. In this way, in the present embodiment, the processor 32 functions as a function switching unit 56 (FIG. 9) that switches between enabling and disabling of the safety function FN1 executed by the processor 32 functioning as the safety function execution unit 50.

While the safety function FN1 is set to be disabled, the processor 32 does not function as the safety function execution unit 50 to execute the safety function FN1. For example, the operator may desire to execute the automatic operation function FN4 described above and operate the robot 12 at a high speed, while being at a sufficient distance from the robot 12 for guaranteeing safety. In this case, the operator can reduce the work cycle time by setting the safety function FN1 to be disabled and operating the robot 12 at a high speed.

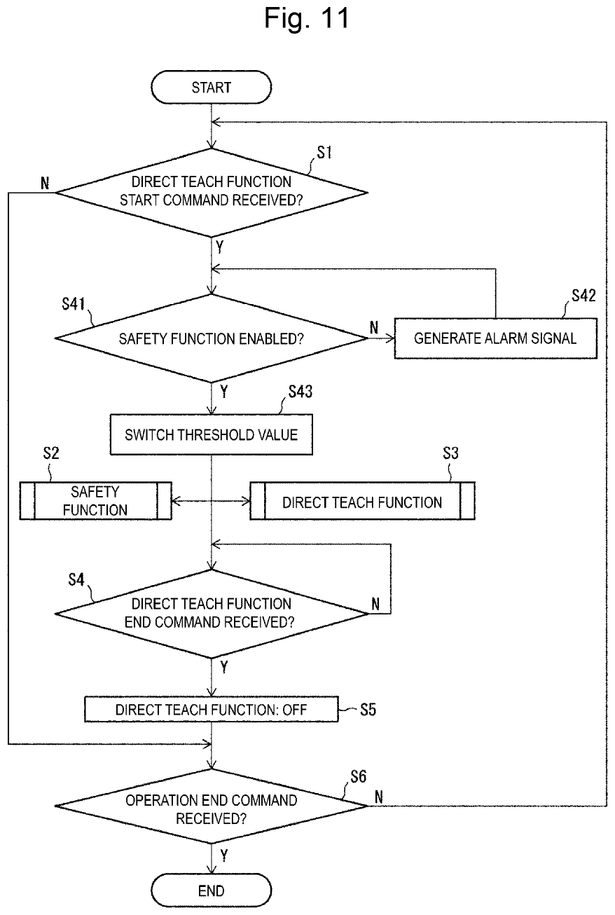

Next, an operation flow executed by the controller 16 illustrated in FIG. 9 will be described with reference to FIG. 11. Note that in the flow illustrated in FIG. 11, the same processing as in the flow of FIG. 3 is denoted by the same step numbers, and redundant descriptions are omitted. In the flow illustrated in FIG. 11, upon determining YES in step S1, the processor 32 proceeds to step S41 before enabling the direct teach function FN2.

In step S41, the processor 32 determines whether or not the safety function FN1 is enabled or disabled. The processor 32 determines YES and proceeds to step S43 when the safety function FN1 is enabled, and determines NO and proceeds to step S42 when the safety function FN1 is disabled.

As described above, in the present embodiment, the processor 32 functions as a safety function determination unit 58 (FIG. 9) that determines whether or not the safety function FN1 is enabled or disabled when the controller 16 has received a command for starting the direct teach function (i.e., the above-described direct teach function start command).

In step S42, the processor 32 generates an alarm signal AL1. For example, the processor 32 generates the alarm signal AL1 as an image or voice indicating “Safety function is disabled. Enable safety function”. Then, the processor 32 displays the generated alarm signal AL1 on the display device 42 (or the display device 44 of the teaching device 18) or outputs the generated alarm signal AL1 through a speaker provided in the controller 16 (or the teaching device 18).

After step S42, the processor 32 returns to step S41. As described above, in the present embodiment, as long as determining NO in step S41, the processor 32 does not start the safety function FN1 in step S2 and the direct teach function FN2 in step S3.

In step S43, the processor 32 switches the threshold values Fcₜₕ, Vₜₕ, and aₜₕ for the safety function FN1 referred to in step S12 (FIG. 5) from first threshold values Fcₜₕ₁, Vₜₕ₁, and aₜₕ₁ to second threshold values Fcₜₕ₂, Vₜₕ₂, and aₜₕ₂. Here, the processor 32 may execute the safety function FN1 in parallel with the teach function FN3, the automatic operation function FN4, or the operation confirmation function FN5 described above. The first threshold values Fcₜₕ₁, Vₜₕ₁, and aₜₕ₁ are referred to by the safety function FN1 that is executed in parallel with the functions FN other than the direct teach function FN2, such as the teach functions FN3, the automatic operation function FN4, or the operation confirmation function FN5.

On the other hand, the second threshold values Fcₜₕ₂, Vₜₕ₂, and aₜₕ₂ are referred to under the safety function FN1 in step S2 in FIG. 11, and are predetermined as values larger than the first threshold values Fcₜₕ₁, Vₜₕ₁, and aₜₕ₁ (i.e., Fcₜₕ₂>Fcₜₕ₁, Vₜₕ₂>Vₜₕ₁, aₜₕ₂>aₜₕ₁).

After this step S43, the processor 32 enables the direct teach function FN2, starts steps S2 and S3, and proceeds to step S4. Then, the processor 32 executes steps S2 and S3 in parallel, and determines in step S12 in step S2, whether or not the operation parameters OP (the contact force Fc, the speed V, and the acceleration a) exceed the second threshold values Fcₜₕ₂, Vₜₕ₂, and aₜₕ₂ as a result of the switching in step S43.

Thereafter, the processor 32 switches the threshold values Fcₜₕ, Vₜₕ, and aₜₕ for the safety function FN1 from the second threshold values Fcₜₕ₂, Vₜₕ₂, and aₜₕ₂ to the first threshold values Fcₜₕ₁, Vₜₕ₁, and aₜₕ₁, for example, when step S5 in FIG. 11 is executed (or determining YES in step S6).

Thus, in the present embodiment, the processor 32 functions as a threshold value switching unit 60 (FIG. 9) that switches the threshold values Fcₜₕ, Vₜₕ, and aₜₕ between the first threshold values Fcₜₕ₁, Vₜₕ₁, and aₜₕ₁ for the functions FN3, FN4, and FN5 other than the direct teach function FN2, and the second threshold values Fcₜₕ₂, Vₜₕ₂, and aₜₕ₂ that are larger than the first threshold values Fcₜₕ₁, Vₜₕ₁, and aₜₕ₁.

As described above, in the present embodiment, the controller 16 further includes the function switching unit 56 that switches between enabling and disabling of the safety function FN1 by the safety function execution unit 50, and the safety function determination unit 58 that determines whether or not the safety function FN1 is enabled or disabled when the direct teach execution unit 52 executes the direct teach function FN2. Specifically, when the controller 16 has received a command for starting the direct teach function FN2 (i.e., the direct teach function start command) (when it is determined YES in step S1), the safety function determination unit 58 determines whether or not the safety function FN1 is enabled or disabled (step S41).

When the safety function determination unit 58 determines that the safety function FN1 is disabled (NO in step S41), the direct teach execution unit 52 does not execute the direct teach function FN2 (step S3). With this configuration, it is possible to reliably avoid execution of the direct teach function FN2 without enabling the safety function FN1 in step S3 in FIG. 11. Thus, the safety of the operator can be reliably guaranteed.

Further, in the present embodiment, the controller 16 further includes the threshold value switching unit 60 that switches the threshold values Fcₜₕ, Vₜₕ, and aₜₕ between the first threshold values Fcₜₕ₁, Vₜₕ₁, and aₜₕ₁ and the second threshold values Fcₜₕ₂, Vₜₕ₂, aₜₕ₂ larger than the first threshold values Fcₜₕ₁, Vₜₕ₁, and aₜₕ₁. When the direct teach execution unit 52 starts the direct teach function FN2, the threshold value switching unit 60 switches the threshold values Fcₜₕ, Vₜₕ, and aₜₕ from the first threshold values Fcₜₕ₁, Vₜₕ₁, and aₜₕ₁ to the second threshold values Fcₜₕ₂, Vₜₕ₂, and aₜₕ₂ (step S43).

With this configuration, when steps S2 and S3 are executed in parallel, it is possible to reliably avoid the determination of YES due to the handling force Fh applied to the robot 12 by the operator in step S12 in step S2. Therefore, the operation of the robot 12 under the direct teach function FN2 can be prevented from unnecessarily stopping, and the safety of the operator can be reliably guaranteed by the safety function FN1.

In the present embodiment, a case is described in which the processor of the teaching device 18 generates the safety function setting image 106 and displays it on the display device 44 of the teaching device 18. However, the present disclosure is not limited thereto, and the processor 32 of the controller 16 may generate the safety function setting image 106 and display it on the display device 42.

In this case, the operator may operate the input device 40 to select the enable button image 108 or the disable button image 110 in the safety function setting image 106 displayed on the display device 42. When the operator selects the enable button image 108, the processor 32 of the controller 16 receives the safety function enabling command through the input device 40.

In the present embodiment, a case is described in which the operator manually provides an input for selecting the safety function FN1 to be enabled or disabled to the processor of the teaching device 18 (or the processor 32 of the controller 16). However, the present disclosure is not limited thereto, and the processor 32 of the controller 16 may function as the function switching unit 56 to automatically set the safety function FN1 to be enabled or disabled without receiving the input from the operator.

For example, the robot system 10 further includes an object detection sensor (a camera, a laser scanner, or the like) capable of detecting an object (e.g., an operator) in the periphery of the robot 12. In this case, the processor 32 functions as the function switching unit 56, and switches the safety function FN1 to be enabled when the object detection sensor detects an object around the robot 12.

On the other hand, when the object detection sensor detects that the object has moved away from the periphery of the robot 12, the processor 32 may switch the safety function FN1 to be disabled and switch a setting value of a maximum speed V_{MAX} of the robot 12 to a higher value. As a result, for example, when the automatic operation function FN4 is executed, the robot 12 can be operated at high speed.

Note that step S43 in FIG. 11 may be executed before step S41 (i.e., when it is determined YES in step S1). Furthermore, steps S41 and S42 may be omitted from the flow illustrated in FIG. 11. In this case, the function switching unit 56 can be omitted from the controller 16 illustrated in FIG. 9.

Alternatively, step S43 may be omitted from the flow in FIG. 11. In this case, the threshold value switching unit 60 can be omitted from the controller 16 illustrated in FIG. 9. In addition, it will be understood that steps S41 to S43 of FIG. 11 can be applied to the flow illustrated in FIG. 7 (i.e., after determining YES in step S1).

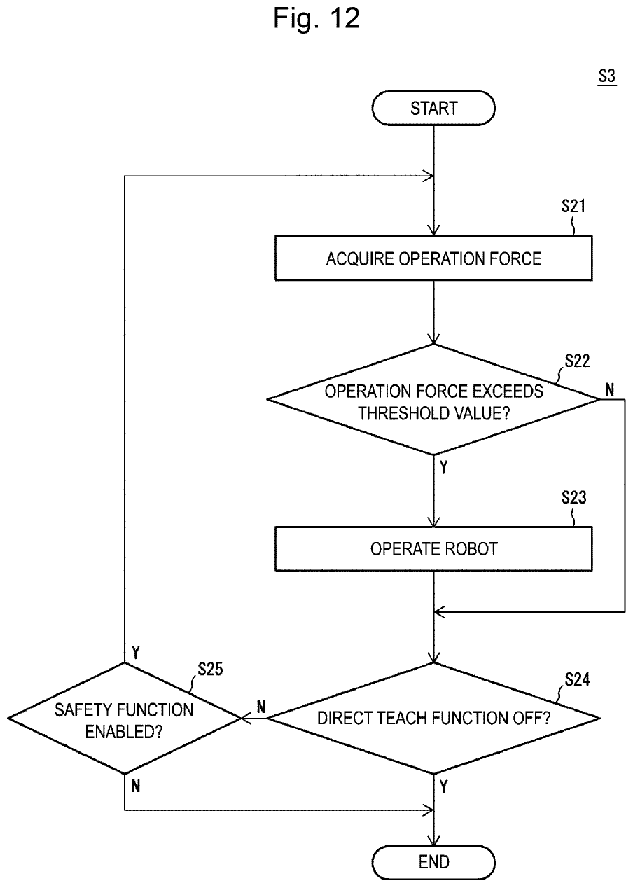

The processor 32 may function as the safety function determination unit 58 when executing step S3 (direct teach function FN2) in FIG. 11 to determine whether or not the safety function FN1 is enabled or disabled, and may end the direct teach function FN2 when the safety function FN1 is disabled. FIG. 12 illustrates a flow of such a direct teach function FN2.

In the flow of step S3 illustrated in FIG. 12, upon determining NO in step S24, in step S25, the processor 32 functions as the safety function determination unit 58 to determine whether or not the safety function FN1 is enabled or disabled, as in step S41 described above.

The processor 32 returns to step S21 upon determining YES, and ends the direct teach function FN2 in step S3 upon determining NO (i.e., when the safety function FN1 is disabled). With the direct teach function FN2 thus ended when the safety function FN1 is disabled during execution of the direct teach function FN2, the safety of the operator can be more reliably guaranteed. Upon determining NO in step S25, the processor 32 may execute step S42 described above to generate the alarm signal AL1.

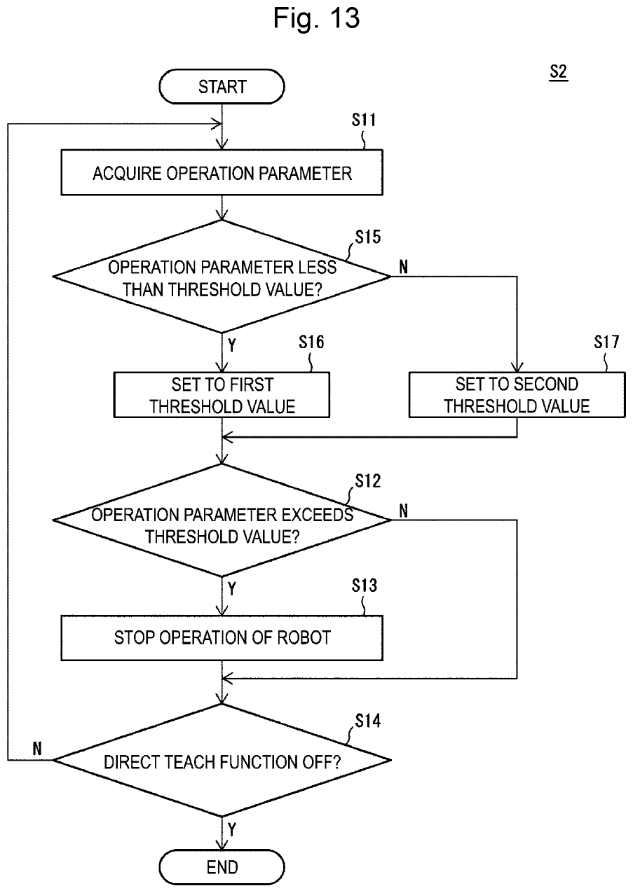

When executing step S2 (safety function FN1) and step S3 (direct teach function FN2) in FIG. 11, step S43 may be omitted from the flow in FIG. 11, and the processor 32 may function as the threshold value switching unit 60 to switch the threshold values Fcₜₕ, Vₜₕ, and aₜₕ referred to in step S12 in step S2 from the first threshold values Fcₜₕ₁, Vₜₕ₁, and aₜₕ₁ to the second threshold values Fcₜₕ₂, Vₜₕ₂, and aₜₕ₂, when the operation parameters OP (the contact force Fc, the speed V, and the acceleration a) exceed third threshold values Fcₜₕ₃, Vₜₕ₃, and aₜₕ₃. Such a flow in step S2 is illustrated in FIG. 13.

In the flow of step S2 illustrated in FIG. 13, after step S11, in step S15, the processor 32 determines whether or not the operation parameters OP (the contact force Fc, the speed V, and the acceleration a) acquired in the most recent step S11 are smaller than the third threshold values Fcₜₕ₃, Vₜₕ₃, and aₜₕ₃.

The third threshold value Fcₜₕ₃, Vₜₕ₃, and aₜₕ₃ are set to values smaller than the threshold value Fcₜₕ, Vₜₕ, and aₜₕ referred to in step S12 (specifically, the first threshold value Fcₜₕ₁, Vₜₕ₁, and aₜₕ₁ and the second threshold value Fcₜₕ₂, Vₜₕ₂, and aₜₕ₂ described above) (i.e., Fcₜₕ₃<Fcₜₕ₁<Fcₜₕ₂, Vₜₕ₃<Vₜₕ₁<Vₜₕ₂, aₜₕ₃<aₜₕ₁<aₜₕ₂).

The processor 32 determines YES and proceeds to step S16 when Fc<Fcₜₕ₃, V<Vₜₕ₃, and a<aₜₕ₃ hold, and determines NO and proceeds to step S17 when Fc≥Fcₜₕ₃, V≥Vₜₕ₃, or a≥aₜₕ₃ hold (i.e., if at least one of the operation parameters OP exceeds the third threshold value Fcₜₕ₃, Vₜₕ₃, or aₜₕ₃). In this step S15, the processor 32 may determine whether or not the speed V and the acceleration a among the operation parameters OP are smaller than the third threshold values Vₜₕ₃ and aₜₕ₃.

In step S16, the processor 32 functions as the threshold value switching unit 60 and sets the threshold values Fcₜₕ, Vₜₕ, and aₜₕ referred to in step S12 to the first threshold values Fcₜₕ₁, Vₜₕ₁, and aₜₕ₁.

On the other hand, upon determining NO in step S15 (i.e., when the operation parameter OP exceeds the third threshold value Fcₜₕ₃, Vₜₕ₃, or aₜₕ₃), the processor 32 functions as the threshold value switching unit 60 in step S17 to set the threshold values Fcₜₕ, Vₜₕ, and aₜₕ referred to in step S12 to the second threshold values Fcₜₕ₂, Vₜₕ₂, and aₜₕ₂. In this step S17, the processor 32 may set the threshold value Fcₜₕ for the contact force Fc to the second threshold value Fcₜₕ₂ without switching the threshold value Vₜₕ for the speed V and the threshold value aₜₕ for the acceleration a from the first threshold values Vₜₕ₁ and aₜₕ₁.

Thereafter, in step S12, the processor 32 refers to the first threshold values Fcₜₕ₁, Vₜₕ₁, or aₜₕ₁ or the second threshold values Fcₜₕ₂, Vₜₕ₂, and aₜₕ₂ currently set, and determines whether or not the operation parameters OP exceeds the first threshold values Fcₜₕ₁, Vₜₕ₁, and aₜₕ₁ or the second threshold values Fcₜₕ₂, Vₜₕ₂, and aₜₕ₂.

Thus, in the flow illustrated in FIG. 13, when at least one of the operation parameters OP is equal to or greater than the third threshold value Fcₜₕ₃, Vₜₕ₃, or aₜₕ₃, the processor 32 switches the threshold values Fcₜₕ, Vₜₕ, and aₜₕ referred to in step S12 from the first threshold values Fcₜₕ₁, Vₜₕ₁, and aₜₕ₁ to the second threshold values Fcₜₕ₂, Vₜₕ₂, and aₜₕ₂ (step S17).

On the other hand, when the operation parameter OP falls below the third threshold value Fcₜₕ₃, Vₜₕ₃, or aₜₕ₃ (i.e., upon determining YES in step S15), the processor 32 switches the threshold values Fcₜₕ, Vₜₕ, and aₜₕ referred to in step S12 from the second threshold values Fcₜₕ₂, Vₜₕ₂, and aₜₕ₂ to the first threshold values Fcₜₕ₁, Vₜₕ₁, and aₜₕ₁.

Here, when the handling force Fh applied to the robot 12 by the operator increases in this step S3 (direct teach function FN2) executed in parallel with step S2, the operation parameter OP (speed V, acceleration a) also increases. The component of the handling force Fh is also included in the external force F detected by the force sensor 14.

According to the present embodiment, by switching the threshold values Fcₜₕ, Vₜₕ, and aₜₕ in response to the operation parameters OP as described above, it is possible to reliably avoid determining YES in step S12 due to the handling force Fh applied to the robot 12 by the operator and consequently executing step S13. On the other hand, when the operation parameter OP is small, it is possible to more reliably detect that the robot 12 has come into contact with an object in the periphery.

In addition, in an example of the present embodiment, in step S15, the processor 32 determines whether or not the speed V or the acceleration a among the operation parameters OP is smaller than the third threshold values Vₜₕ₃ or aₜₕ₃. Then, in steps S16 and S17, the processor 32 switches the threshold value Fcₜₕ for the contact force Fc between the first threshold value Fcₜₕ₁ and the second threshold value Fcₜₕ₂ in response to the speed V or the acceleration a.

Then, in step S12, the processor 32 refers to the first threshold value Fcₜₕ₁ or the second threshold value Fcₜₕ₂ currently set, and determines whether or not the contact force Fc acquired as the operation parameter OP exceeds the first threshold value Fcₜₕ₁ or the second threshold value Fcₜₕ₂.

That is, in this case, the processor 32 determines whether or not one of the operation parameters OP (speed V, acceleration a) is smaller than the third threshold value (Vₜₕ₃, aₜₕ₃) in step S15, and switches the threshold value (Fcₜₕ) for the other operation parameter OP (contact force Fc) between the first threshold value (Fcₜₕ₁) and the second threshold value (Fcₜₕ₂) in steps S16 and S17.

Then, in step S12, the processor 32 determines whether or not the other operation parameter OP exceeds the threshold value (Fcₜₕ₁ or Fcₜₕ₂) after the switching. With this configuration, it is possible to more reliably prevent step S13 from being executed due to the handling force Fh applied to the robot 12 with the direct teach function S13 under the direct teach function FN2.

Note that the processor 32 may execute step S43 in the flow of FIG. 11, and also execute the flow of FIG. 13 in step S2 in FIG. 11. In this case, in step S16 in FIG. 13, the processor 32 functions as the threshold value switching unit 60, and sets the threshold values Fcₜₕ, Vₜₕ, and aₜₕ referred to in step S12 to the second threshold values Fcₜₕ₂, Vₜₕ₂, and aₜₕ₂ switched in step S43.

On the other hand, in step S17 in FIG. 13, the processor 32 functions as the threshold value switching unit 60 to set the threshold values Fcₜₕ, Vₜₕ, and aₜₕ referred to in step S12 to fourth threshold values Fcₜₕ₄, Vₜₕ₄, and aₜₕ₄. The fourth threshold values Fcₜₕ₄, Vₜₕ₄, and aₜₕ₄ are set to values larger than the second threshold values Fcₜₕ₂, Vₜₕ₂, and aₜₕ₂ (i.e., Fcₜₕ₄>Fcₜₕ₂, Vₜₕ₄>Vₜₕ₂, and aₜₕ₄>aₜₕ₂).

That is, in this case, the processor 32 functions as the threshold value switching unit 60 to switch the threshold values Fcₜₕ, Vₜₕ, and aₜₕ referred to in step S12 between the threshold values Fcₜₕ₂, Vₜₕ₂, and aₜₕ₂ (first threshold values) and the threshold values Fcₜₕ₄, Vₜₕ₄ and aₜₕ₄ (second threshold values) in response to the operation parameters OP. In this case, the processor 32 may determine whether or not one of the operation parameters OP (speed V, acceleration a) is smaller than the third threshold value (Vₜₕ₃, aₜₕ₃) in step S15, and switch the threshold value (Fcₜₕ) for the other operation parameter OP (contact force Fc) between the first threshold value (Fcₜₕ₂) and the second threshold value (Fcₜₕ₄) in steps S16 and S17.

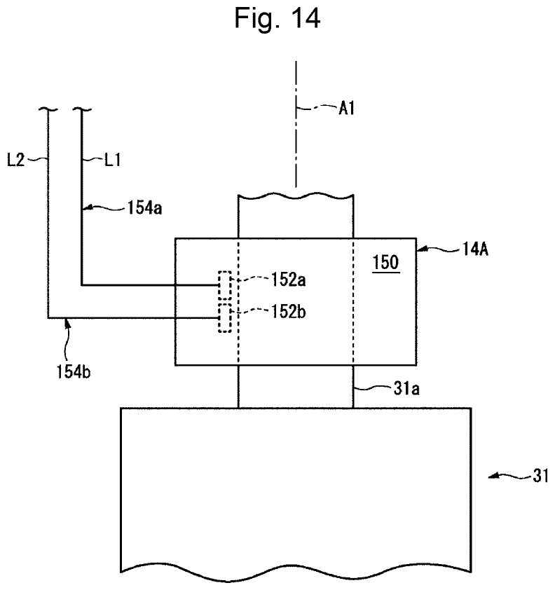

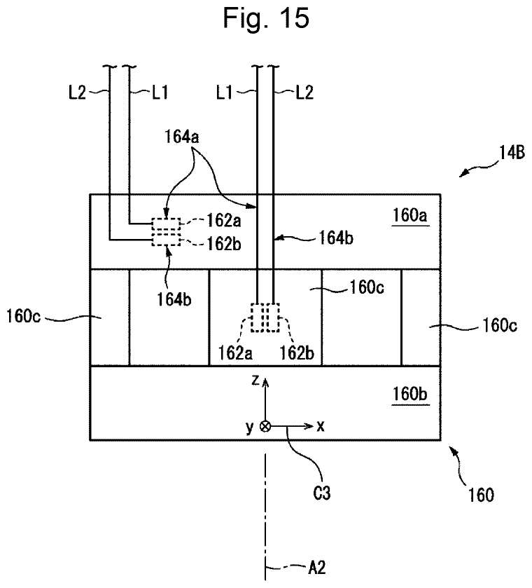

Next, various embodiments of the force sensor 14 will be described with reference to FIG. 14 and FIG. 15. The force sensor 14 may include at least one of the torque sensor 14A and the force detection sensor 14B described above. FIG. 14 illustrates the torque sensor 14A according to an embodiment. The torque sensor 14A is provided to the output shaft 31a of the actuator 31. Specifically, the torque sensor 14A includes a cylindrical main body 150 having a center axis A1, and a pair of sensor devices 152a and 152b incorporated in the main body 150. The main body 150 is coaxially fitted to the output shaft 31a so as to surround the output shaft 31a.

Each of the pair of sensor devices 152a and 152b includes, for example, a strain gauge such as a semiconductor strain gauge or a metal-foil strain gauge, a proximity sensor, an optosensor, a laser-type or capacitance-type displacement meter, or an optical or magnetic encoder. The sensor devices 152a and 152b convert strain, deformation, or displacement occurring in the main body 150 due to the torque τ applied to the output shaft 31a into electric signals, and output the electric signals as detection data DDτₐ and detection data DDτ_{b} respectively.

The detection data DDτₐ output from the sensor device 152a is supplied to the controller 16 through a signal line L1. The sensor devices 152a and the signal lines L1 form a first-line detection part 154a. The detection data DDτ_{b} output from the sensor device 152b is supplied to the controller 16 through a signal line L2 that is independent of (specifically, insulated from) the signal line L1. The sensor device 152b and the signal line L2 form a second-line detection part 154b.

Note that the signal lines L1 and L2 may be wired lines or wireless lines (i.e., transmission paths for wireless communication). As described above, in the present embodiment, the detection data DDτₐ of the sensor device 152a and the detection data DDτ_{b} of the sensor device 152b are individually supplied to the controller 16 through the signal lines L1 and L2 that are independent from each other.

The pair of sensor devices 152a and 152b are disposed adjacent to each other at the same part of the main body 150 so as to detect a force in one direction (specifically, the torque τ applied from the output shaft 31a in the circumferential direction of the main body 150). Therefore, the detection data DDτₐ of the sensor device 152a and the detection data DDτ_{b} of the sensor device 152b are substantially equal to each other. For example, the sensor devices 152a and 152b may be arranged to be stacked one on top of the other (or in parallel). As described above, in the present embodiment, the two-line detection parts 154a and 154b detect the force (torque τ) in one direction, and individually supply the detection data DDτₐ and DDτ_{b} to the controller 16.

FIG. 15 illustrates the force detection sensor 14B according to an embodiment. The force detection sensor 14B is a six-axis force sensor, and is provided to the robot base 20, for example. Specifically, the force detection sensor 14B includes a cylindrical main body 160 having a center axis A2, and a plurality of pairs of sensor devices 162a and 162b provided to the main body 160. The main body 160 includes a pair of ring portions 160a and 160b extending in the circumferential direction and being separated from each other in the axial direction, and a plurality of column portions 160c extending between the ring portions 160a and 160b and disposed at a substantially equal interval in the circumferential direction.

In the example illustrated in FIG. 15, each of the ring portion 160a and the column portion 160c is provided with the pair of sensor devices 162a and 162b. Each of the pair of sensor devices 162a and 162b includes, for example, a strain gauge such as a semiconductor strain gauge or a metal-foil strain gauge, a proximity sensor, an optosensor, a laser-type or capacitance-type displacement meter, an optical or magnetic encoder, or the like, similarly to the sensor devices 152a and 152b described above. The sensor devices 162a and 162b convert strain, deformation, or displacement occurring in the main body 160 due to a force f applied to the main body 160 into electric signals, and output the electric signals as detection data pieces DDfₐ and DDf_{b} respectively.

The pair of sensor devices 162a and 162b provided to the ring portion 160a are disposed adjacent to the same part of the ring portion 160a so as to detect a force in one direction (specifically, the force f applied in the axial direction of the ring portion 160a). Similarly, the pair of sensor devices 162a and 162b provided to the column portion 160c are adjacently disposed at the same part of the column portion 160c so as to detect a force in one direction (specifically, the force f in a direction around the axis A2 applied to the column portion 160c). The detection data DDfₐ of the sensor device 162a is substantially equal to the detection data DDf_{b} of the sensor device 162b. For example, the sensor devices 162a and 162b may be arranged to be stacked one on top of the other (or in parallel).

The detection data DDfₐ output from each sensor device 162a is supplied to the controller 16 through the signal line L1. The sensor device 162a and the signal line L1 form a first-line detection part 164a. The controller 16 executes a predetermined calculation CL3 based on the detection data DDfₐ of each sensor device 162a, thereby detecting forces in six axial directions including a force fx in the x-axis direction, a force fy in the y-axis direction, and a force fz in the z-axis direction in a sensor coordinate system C3 set to the main body 160 of the force detection sensor 14B, as well as a torque τx around the x-axis, a torque τy around the y-axis, and a torque τz around the z-axis.

The sensor coordinate system C3 is a control coordinate system for calculating the external force F applied to the robot 12 from the detection data DDf of the force detection sensor 14B. For example, the sensor coordinate system C3 is set to the main body 160 to have the origin disposed on the center axis A2 (e.g., the center point) of the main body 160 and to have the z-axis coinciding with the center axis A2 of the main body 160. From the forces fx, fy, fz, τx, τy, and τz in the six axial directions obtained as described above, the controller 16 can obtain the magnitude and direction of the external force F applied to the robot 12, and can identify the part of the robot 12 to which the external force F is applied.

The detection data DDf_{b} output from each sensor device 162b is supplied to the controller 16 through the signal line L2. The sensor device 162b and the signal line L2 form a second-line detection part 164b. Based on the detection data DDf_{b} of each sensor device 162b, the controller 16 obtains the above-described forces fx, fy, fz, τx, τy, and τz in the six axial directions by executing the predetermined calculation CL3, and thus can identify the magnitude and direction of the external force F applied to the robot 12 and the part of the robot 12 to which the external force F is applied. As described above, in the present embodiment, the two-line detection parts 164a and 164b detect the force f in one direction, and individually supply the detection data pieces DDfₐ and DDf_{b} to the controller 16.

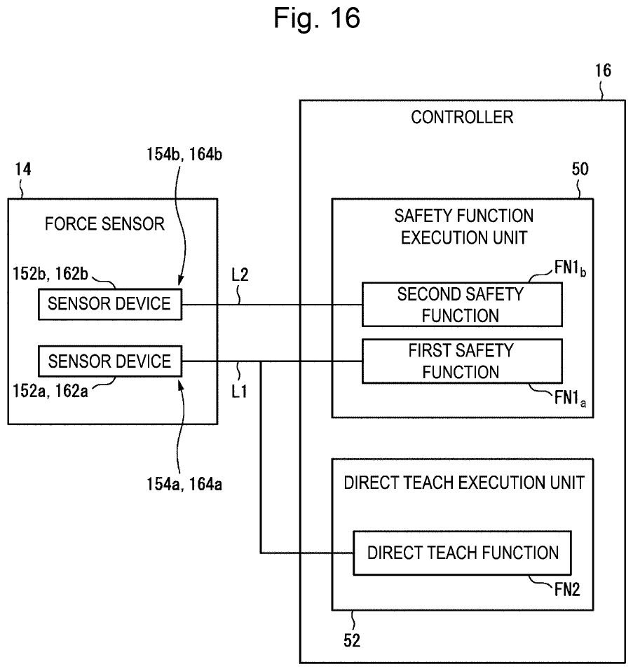

Next, the safety function FN1 and the direct teach function FN2 executed based on the detection data pieces DDτₐ and DDτ_{b} of the torque sensors 14A illustrated in FIG. 14 will be described with reference to FIG. 16. In the present embodiment, the safety function execution unit 50 (specifically, the processor 32) concurrently executes in parallel the first safety function FN1ₐ of monitoring a first contact force Fcₐ obtained based on the detection data DDτₐ of the first-line detection part 154a (i.e., one sensor device 152a) and a second safety function FN1_{b} of monitoring a second contact force Fc_{b} obtained based on the detection data DDτ_{b} of the second-line detection part 154b (i.e., the other sensor device 152b). Each of the first safety function FN1ₐ and the second safety function FN1_{b} corresponds to, for example, the flow of step S2 illustrated in FIG. 5.

Thus, the safety function execution unit 50 executes the flow of step S2 as the first safety function FN1ₐ, based on the detection data DDτₐ acquired from one sensor device 152a of each torque sensor 14A through the signal line L1. The safety function execution unit 50 executes, in parallel with the first safety function FN1ₐ, the flow of step S2 as the second safety function FN1ₐ, based on the detection data DDτ_{b} acquired from the other sensor device 152b of each torque sensor 14A through the signal line L2. Therefore, when it is determined YES in any one of step S2 executed as the first safety function FN1ₐ and step S2 executed as the second safety function FN1_{b}, the robot 12 is stopped (step S13).

With the first safety function FN1ₐ and the second safety function FN1_{b} thus individually executed based on the detection signals DDτₐ and DDτ_{b} of the detection parts 154a and 154b of different lines (i.e., different sensor devices 152a and 152b), even if the detection part 154a of one line (e.g., the sensor device 152a) fails, the second safety function FN1_{b} can be continuously executed by using the detection data DDτ_{b} of the detection part 154b of the other line (e.g., the sensor device 152b). Thus, the safety of the operator can be more reliably guaranteed.

On the other hand, the direct teach execution unit 52 (processor 32) executes the direct teach function FN2 (step S3 illustrated in FIG. 6) in parallel with the first safety function FN1ₐ and the second safety function FN1_{b} executed by the safety function execution unit 50. Specifically, the direct teach execution unit 52 executes the flow of step S3 based on the detection data DDτₐ acquired from one sensor device 152a of each torque sensor 14A through the signal line L1. At this time, the direct teach execution unit 52 obtains the handling force Fh based on the detection data DDτₐ of the detection part 154a of one line (i.e., one sensor device 152a) in step S21 in step S3.

The safety functions FN1ₐ and FN1_{b} as well as the direct teach function FN2 executed based on the detection data DDfₐ and DDf_{b} of the force detection sensor 14B illustrated in FIG. 15 are also the same as the case where the torque sensor 14A is used. Specifically, the safety function execution unit 50 concurrently executes in parallel the first safety function FN1ₐ (flow of FIG. 5) of monitoring the first contact force Fcₐ obtained based on the detection data DDfₐ of the first-line detection part 164a (i.e., each of the one sensor devices 162a) and the second safety function FN1_{b} (flow of FIG. 5) of monitoring the second contact force Fc_{b} obtained based on the detection data DDf_{b} of the second-line detection part 164b (i.e., each of the other sensor devices 162b).

In parallel with the first safety function FN1ₐ and the second safety function FN1_{b}, the direct teach execution unit 52 executes the direct teach function FN2 (flow in FIG. 6) by obtaining the handling force Fh based on the detection data DDfₐ of the first-line detection part 164a acquired from each of the one sensor devices 162a of the force detection sensor 14B through the signal line L1.

The processor 32 of the controller 16 illustrated in FIG. 16 may execute the flow illustrated in FIG. 3 or 7. When executing the flow in FIG. 7, in step S3′, the processor 32 functions as the direct teach execution unit 52 to execute the flow of the direct teach function FN2′ illustrated in FIG. 8 based on the detection data DDτₐ or DDfₐ of the first-line detection part 154a or 164a acquired from one sensor device 152a or 162a.

In addition, the processor 32 may execute a loop of steps S11 to S14 in step S2 executed as the first safety function FN1ₐ, a loop of steps S11 to S14 in step S2 executed as the second safety function FN1_{b}, and a loop of steps S21 to S24 in step S3 executed as the direct teach function FN2 at a predetermined control interval (e.g., 1 [msec]) in synchronization with each other (or alternately).

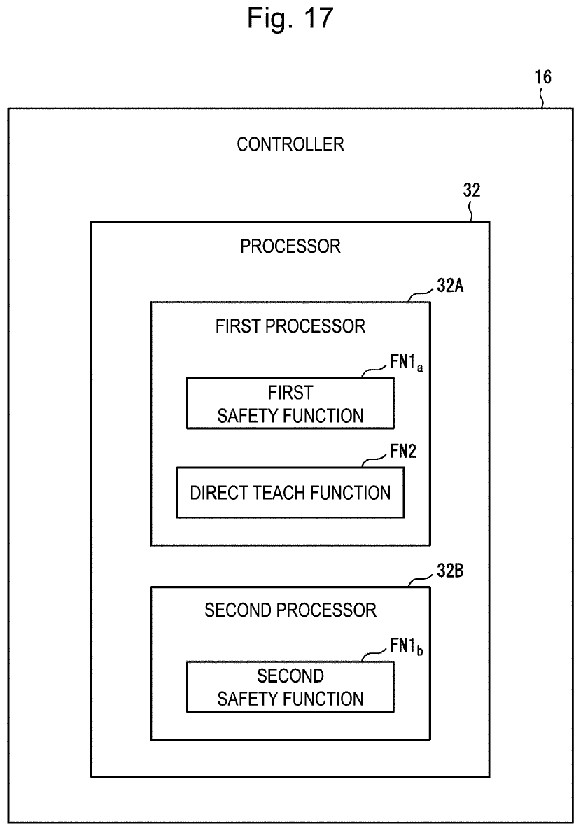

The processor 32 may include a first processor 32A that executes the first safety function FN1ₐ and the direct teach function FN2 and a second processor 32B that executes the second safety function FN1_{b}. Such an embodiment is illustrated in FIG. 17. In this embodiment, the first processor 32A and the second processor 32B function as the safety function execution unit 50, while the first processor 32A functions as the direct teach execution unit 52.

The processor 32 is not limited to the embodiment illustrated in FIG. 17, and may include the first processor 32A that executes the first safety function FN1ₐ, the second processor 32B that executes the second safety function FN1_{b}, and a third processor 32C that executes the direct teach function FN2.

In the direct teach function FN2, the direct teach execution unit 52 may obtain the handling force Fh based on both of the detection data DDτₐ (or DDfₐ) of the first-line detection part 154a (or 164a) and the detection data DDτ_{b} (or DDf_{b}) of the second-line detection part 154b (or 164b).

For example, when the torque sensor 14A illustrated in FIG. 14 is used to execute the direct teach function FN2, the direct teach execution unit 52 may obtain an average value DDτ_{AVE} of the detection data DDτₐ of one sensor device 152a and the detection data DDτ_{b} of the other of the sensor device 152b, and obtain the handling force Fh based on the average value DDτ_{AVE}.

Alternatively, the processor 32 may select a larger one (or a smaller one) of the detection data DDτₐ (or DDfₐ) of the first-line detection part 154a (or 164a) and the detection data DDτ_{b} (or DDf_{b}) of the second-line detection part 154b (or 164b), and obtain the handling force Fh using the larger one (or smaller one) selected.

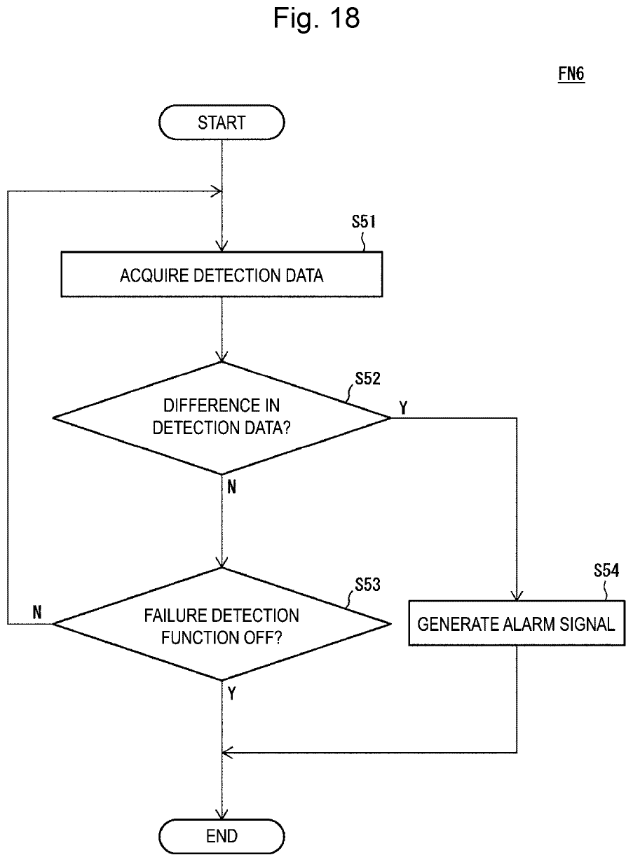

When executing the first safety function FN1ₐ and the second safety function FN1_{b}, the processor 32 of the controller 16 illustrated in FIG. 16 or FIG. 17 may execute in parallel a failure detection function FN6 of detecting whether or not any one of the first-line detection part 154a or 164a (e.g., one sensor device 152a or 162a) and the second-line detection part 154b or 164b (e.g., the other sensor device 152b or 162b) has failed. This failure detection function FN6 will be described with reference to FIG. 18.

The processor 32 starts the flow illustrated in FIG. 18 when the failure detection function FN6 is enabled. This failure detection function FN6 may be automatically enabled by the processor 32, for example, when starting the safety function FN1 (first safety function FN1ₐ and the second safety function FN1_{b}). Hereinafter, the failure detection function FN6 in a case where the force sensor 14 includes the torque sensor 14A will be described.

In step S51, the processor 32 acquires the detection data pieces DDτₐ and DDτ_{b} of the two-line detection parts 154a and 154b (specifically, the pair of sensor devices 152a and 152b). For example, in this step S51, the processor 32 acquires the detection data pieces DDτ_{Sa} and DDτ_{b} detected by the pair of sensor devices 152a and 152b at the same time point (or at very close time points).

In step S52, the processor 32 determines whether or not the detection data pieces DDτₐ and DDτ_{b} acquired in the most recent step S51 are different from each other. For example, when a difference Δ_{D} between the detection data DDτₐ and DDτ_{b} exceeds a predetermined threshold value Δ_{Dth} (Δ_{D}≥Δ_{Dth}), the processor 32 determines that the detection data pieces DDτₐ and DDτ_{b} are different from each other (i.e., determines YES). The processor 32 proceeds to step S54 upon determining YES, and proceeds to step S53 upon determining NO.

In step S53, the processor 32 determines whether or not the failure detection function FN6 is disabled. The processor 32 ends the failure detection function FN6 upon determining YES, and returns to step S51 upon determining NO.

On the other hand, upon determining YES in step S52, the processor 32 generates an alarm signal AL2 in step S54. For example, the processor 32 may generate the alarm signal AL2 as an image or a voice indicating “Force sensor may have failed. Perform maintenance for force sensor”, and output the signal to the display device 42 or 44 or to a speaker.

Upon determining YES in step S52, the processor 32 may execute the above-described emergency stop operation ES to stop the robot 12. In addition, the processor 32 may execute the loop of steps S11 to S14 in step S2 executed as the safety function FN1 (the first safety function FN1ₐ and the second safety function FN1_{b}), and the loop of steps S51 to S53 executed as the failure detection function FN6 in synchronization with each other (or alternately) at a predetermined control interval (e.g., 1 [msec]).

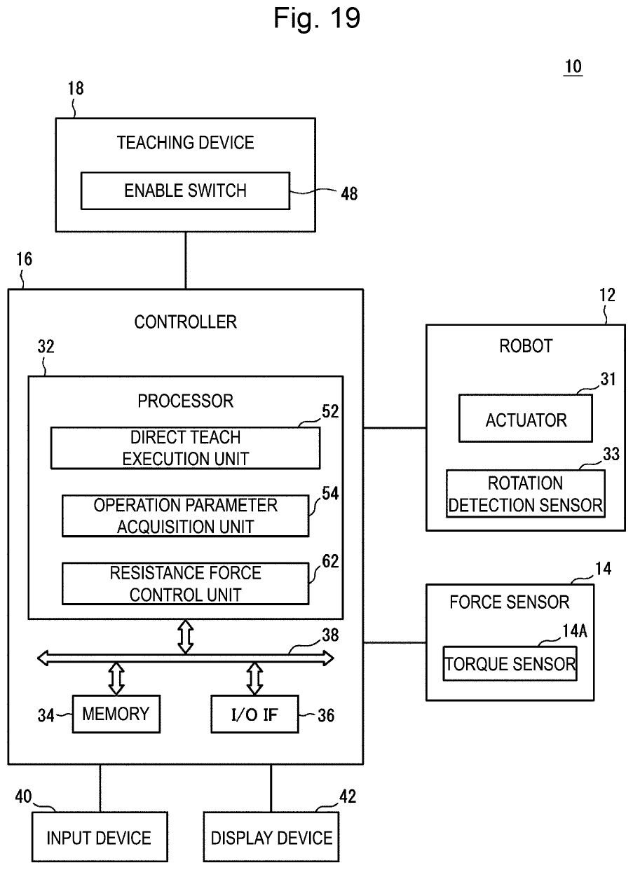

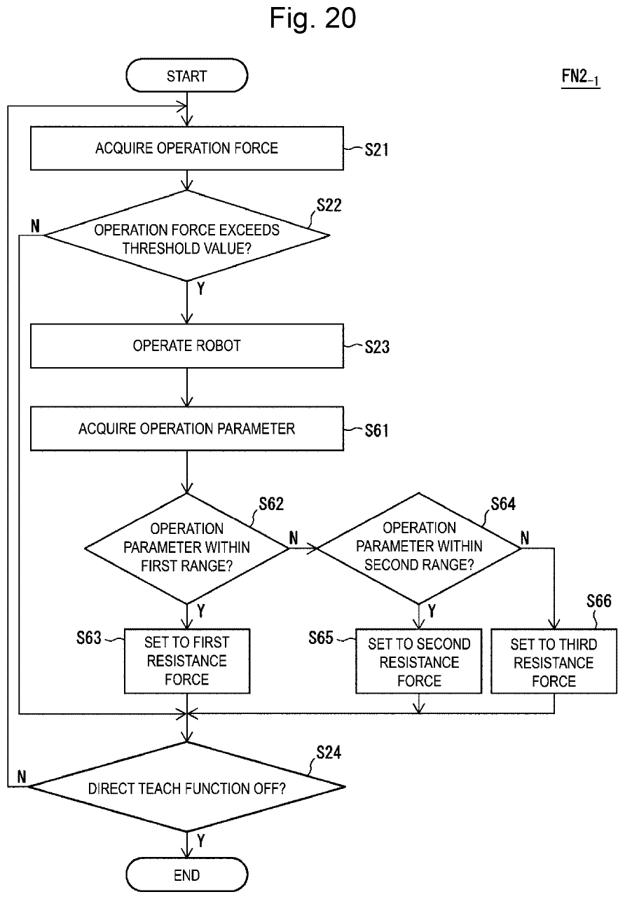

Subsequently, still another function of the robot system 10 will be described with reference to FIG. 19 and FIG. 20. In the present embodiment, the controller 16 executes the flow illustrated in FIG. 20 as a direct teach function FN2_{_1} according to still another embodiment. Note that in the flow illustrated in FIG. 20, processes similar to those of the flow illustrated in FIG. 6 are assigned identical step numbers, and overlapping descriptions thereof will be omitted.

In the flow illustrated in FIG. 20, the processor 32 functions as the direct teach execution unit 52 and executes steps S21 to S23, and executes steps S61 to S66 after step S23. In step S61, the processor 32 functions as the operation parameter acquisition unit 54 and acquires the operation parameter OP.

In the present embodiment, the processor 32 acquires at least one of the speed V of the robot 12 and the acceleration a of the robot 12 as the operation parameter OP in this step S61. Hereinafter, a case where the processor 32 acquires the speed V as the operation parameter OP in this step S61 will be described.

In step S62, the processor 32 determines whether or not the operation parameter OP (speed V) acquired in the most recent step S61 is within a first range. Specifically, the processor 32 determines whether or not the speed V acquired in the most recent step S61 falls within the first range [Vₜₕ₁₁≤V<Vₜₕ₁₂]. The threshold values Vₜₕ₁₁ and Vₜₕ₁₂ defining this first range may be predetermined by the operator. The smallest threshold value Vₜₕ₁₁ is set to, for example, 0. The processor 32 determines YES and proceeds to step S63 when Vₜₕ₁₁≤V<Vₜₕ₁₂ holds, and proceeds to step S64 upon determining NO (i.e., when Vₜₕ₁₂≤V).

In step S63, the processor 32 sets a resistance force RF against the handling force Fh applied to the robot 12 to a first resistance force RF1. Here, an acceleration setting value α that defines the maximum value of the acceleration a of the robot 12 is preset in the controller 16. An increase in the acceleration setting value α may lead to an increase in the acceleration a of the robot 12 operating in accordance with the handling force Fh. In this case, since the response of the robot 12 to the handling force Fh applied by the operator becomes faster (in other words, the operation feeling becomes lighter), the resistance force RF against the handling force Fh decreases.

On the other hand, a decrease in the acceleration setting value α may lead to a decrease in the acceleration a of the robot 12 operating in accordance with the handling force Fh. In this case, since the response of the robot 12 to the handling force Fh applied by the operator becomes slower (in other words, the operation feeling becomes heavier), the resistance force RF against the handling force Fh increases.

Therefore, in the present embodiment, the processor 32 changes the resistance force RF against the handling force Fh by changing the acceleration setting value α in response to the speed V acquired in step S61. In this step S63, the processor 32 sets the acceleration setting value α to a first acceleration setting value α1, thereby setting the resistance force RF against the handling force Fh to the first resistance force RF1 corresponding to the first acceleration setting value α1. Note that the first acceleration setting value α1 may be an initial value (or a default value) set at the start of the direct teach function FN2_{_1}.

On the other hand, upon determining NO in step S62, in step S64, the processor 32 determines whether or not the operation parameter OP (speed V) acquired in the most recent step S61 is within a second range larger than the first range. Specifically, the processor 32 determines whether or not the speed V acquired in the most recent step S61 falls within the second range [Vₜₕ₁₂≤V<Vₜₕ₁₃]. The threshold value Vₜₕ₁₃ defining the upper limit of the second range may be predetermined by the operator. The processor 32 determines YES and proceeds to step S65 when Vₜₕ₁₂≤V<Vₜₕ₁₃ holds, and proceeds to step S66 upon determining NO (i.e., when Vₜₕ₁₃≤V).

In step S65, the processor 32 sets the resistance force RF against the handling force Fh applied to the robot 12 to a second resistance force RF2 (>RF1). Specifically, the processor 32 can set the resistance force RF against the handling force Fh to the second resistance force RF2 larger than the first resistance force RF1 by setting the acceleration setting value α to a second acceleration setting value α2 (<α1).

On the other hand, upon determining NO in step S64, in step S66, the processor 32 sets the resistance force RF against the handling force Fh applied to the robot 12 to a third resistance force RF3 (>RF2). Specifically, the processor 32 can set the resistance force RF against the handling force Fh to the third resistance force RF3 larger than the second resistance force RF2 by setting the acceleration setting value α to a third acceleration setting value α3 (<α2).

In this way, by executing steps S63, S65, and S66, the processor 32 can change the acceleration setting value α to α1, α2, or α3, and thereby change the resistance force RF against the handling force Fh in response to the speed V acquired in step S61. Therefore, the processor 32 functions as a resistance force control unit 62 (FIG. 19) that changes the resistance force RF against the handling force Fh. After executing step S63, S65, or S66 while serving as the resistance force control unit 62, the processor 32 proceeds to step S24 and determines whether or not the direct teach function FN2_{_1} is disabled.

Thus, the processor 32 executes steps S61 to S66 during execution of the direct teach function FN2_{_1}, and controls the resistance force RF against the handling force Fh in response to the operation parameter OP (specifically, the speed V). Although detailed description is omitted, it should be understood that also in a case where the acceleration a is acquired as the operation parameter OP in step S61, the processor 32 can similarly execute steps S62 to S66 based on the acceleration a.

As described above, in the present embodiment, the controller 16 includes the direct teach execution unit 52, the operation parameter acquisition unit 54 that acquires the speed V (or the acceleration a) of the robot 12 during the execution of the direct teach function FN2_{_1}, and the resistance force control unit 62 that changes the resistance force RF against the handling force Fh in response to the speed V (or the acceleration a) acquired by the operation parameter acquisition unit 54.

With this configuration, an increase in the speed V (or acceleration a) of the robot 12 during the execution of the direct teach function FN2_{_1} is provided as feedback in a form of the resistance force RF against the operation feeling on the robot 12 felt by the operator, and thus the operator can intuitively recognize the increase. Thus, it is possible to avoid an excessive increase in the speed V (or the acceleration a) during the execution of the direct teach function FN2_{_1}.

Further, in the present embodiment, the resistance force control unit 62 changes the resistance force RF by changing the acceleration setting value α that defines the maximum value of the acceleration a to α1, α2, or α3 in response to the speed V (or acceleration a) acquired by the operation parameter acquisition unit 54. With this configuration, the processor 32 can swiftly change the resistance force RF using a relatively simple algorithm.

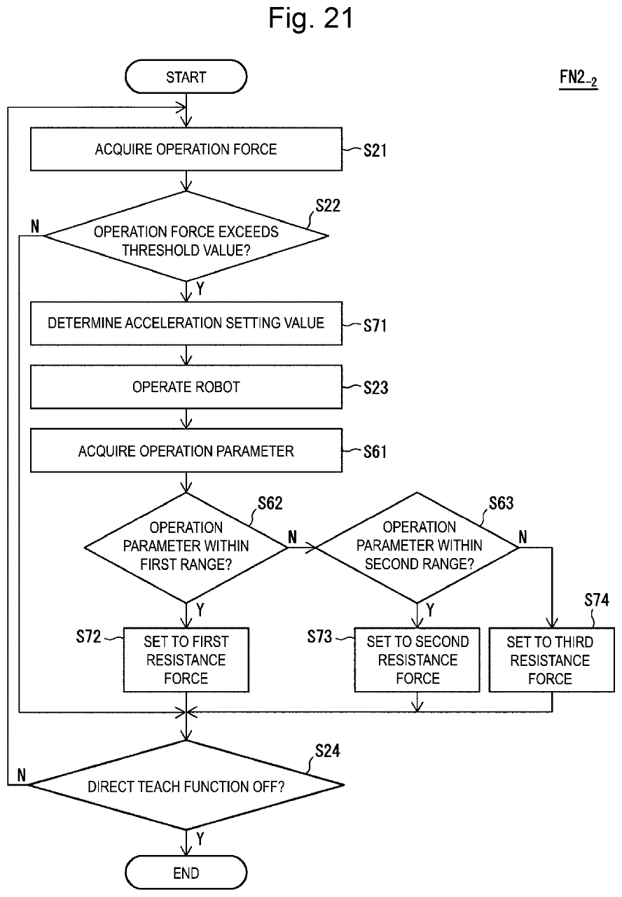

Next, a direct teach function FN2_{_2} according to yet still another embodiment will be described with reference to FIG. 21. The controller 16 illustrated in FIG. 19 executes the flow illustrated in FIG. 21 as the direct teach function FN2_{_2}. Note that in the flow illustrated in FIG. 21, processes similar to those of the flow illustrated in FIG. 20 are assigned identical step numbers, and overlapping descriptions thereof will be omitted.

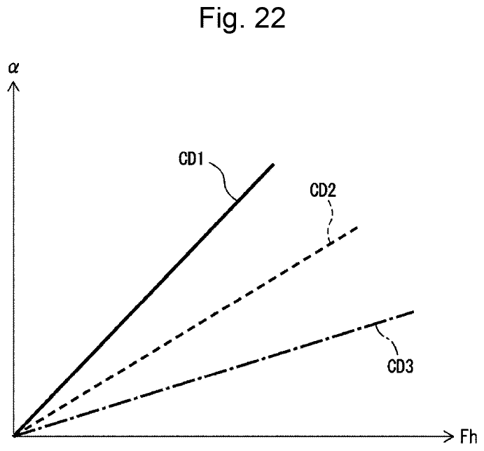

In the flow illustrated in FIG. 21, the processor 32 executes step S71 upon determining YES in step S22. In step S71, the processor 32 functions as the direct teach execution unit 52, and applies the handling force Fh acquired in the most recent step S21 to characteristic data CD to determine the acceleration setting value α. The characteristic data CD is data (in other words, a graph) indicating a relationship between the handling force Fh and the acceleration setting value α. FIG. 22 illustrates an example of the characteristic data CD.

In the example illustrated in FIG. 22, first characteristic data CD1, second characteristic data CD2, and third characteristic data CD3 are illustrated. The first characteristic data CD1 has the largest slope δα/δFh. Therefore, in the first characteristic data CD1, the acceleration setting value α for the handling force Fh (i.e., the maximum value of the acceleration α of the robot 12 when executing the direct teach function FN2_{_2}) is larger than those in the second characteristic data CD2 and the third characteristic data CD3.

Thus, since the response of the robot 12 to the handling force Fh applied by the operator becomes faster (in other words, the operation feeling becomes lighter), the resistance force RF against the handling force Fh becomes smaller than those in the second characteristic data CD2 and the third characteristic data CD3. Note that the first characteristic data CD1 may be initial data (or default data) set as the characteristic data CD at the start of the direct teach function FN2_{_2}.

On the other hand, the third characteristic data CD3 has the smallest slope δα/δFh. Therefore, in the third characteristic data CD3, the acceleration setting value α for the handling force Fh is smaller than those in the first characteristic data CD1 and the second characteristic data CD2. Thus, since the response of the robot 12 to the handling force Fh applied by the operator becomes slower (in other words, the operation feeling becomes heavier), the resistance force RF against the handling force Fh becomes larger than those in the first characteristic data CD1 and the second characteristic data CD2.

In the second characteristic data CD2, the magnitude of the resistance force RF is between those in the first characteristic data CD1 and the third characteristic data CD3. Thus, the characteristic data pieces CD1, CD2, and CD3 are correlated with the resistance force RF against the handling force Fh. The characteristic data pieces CD1, CD2, and CD3 are pre-stored in the memory 34.

In order to operate the robot 12 in step S23 in FIG. 21, one of the characteristic data pieces CD1, CD2, and CD3 is selected and set as the characteristic data CD for determining the acceleration setting value α. For example, it is assumed that the first characteristic data CD1 has been set at the start of this step S71. In this case, the processor 32 functions as the direct teach execution unit 52 in this step S71, and applies the handling force Fh acquired in the most recent step S21 to the first characteristic data CD1 illustrated in FIG. 22 to determine the acceleration setting value α.

Then, in step S23, the processor 32 functions as the direct teach execution unit 52 to operate the robot 12 in response to the handling force Fh acquired in the most recent step S71 using the acceleration setting value α determined in the most recent step S21. The acceleration a of the robot 12 operating at this time is controlled to be equal to or less than the acceleration setting value α.

On the other hand, upon determining YES in step S62, in step S72, the processor 32 functions as the resistance force control unit 62 and sets the resistance force RF against the handling force Fh to the first resistance force RF1. Specifically, the processor 32 sets the above-described characteristic data CD to the first characteristic data CD1 in FIG. 22. As described above, the characteristic data pieces CD1, CD2, and CD3 are correlated with the resistance force RF. Therefore, by selecting the first characteristic data CD1, the resistance force RF can be set to the first resistance force RF1 corresponding to the first characteristic data CD1.

On the other hand, upon determining YES in step S63, in step S73, the processor 32 functions as the resistance force control unit 62 and sets the resistance force RF against the handling force Fh to the second resistance force RF2. Specifically, the processor 32 sets the above-described characteristic data CD to the second characteristic data CD2 in FIG. 22.

Thus, the resistance force RF can be set to the second resistance force RF2 corresponding to the second characteristic data CD2. As described above, the second resistance force RF2 in the second characteristic data CD2 is greater than the first resistance force RF1 in the first characteristic data CD1 (RF2>RF1).

On the other hand, upon determining NO in step S63, in step S74, the processor 32 functions as the resistance force control unit 62 and sets the resistance force RF against the handling force Fh to the third resistance force RF3. Specifically, the processor 32 sets the above-described characteristic data CD to the third characteristic data CD3 in FIG. 22.

Thus, the resistance force RF can be set to the third resistance force RF3 corresponding to the third characteristic data CD3. As described above, the third resistance force RF3 in the third characteristic data CD3 is the largest (RF3>RF2>RF1). After executing step S72, S73, or S74 while serving as the resistance force control unit 62, the processor 32 proceeds to step S24 and determines whether or not the direct teach function FN2_{_2} is disabled.

As described above, in the present embodiment, the characteristic data CD (CD1, CD2, CD3) indicating the relationship between the handling force Fh and the acceleration setting value α is pre-stored in the memory 34, and the direct teach execution unit 52 applies the handling force Fh to the characteristic data CD to determine the acceleration setting value α when executing the direct teach function FN2_{_2} (step S71).

Then, the resistance force control unit 62 changes the resistance force RF by changing the characteristic data CD to the first characteristic data CD1, the second characteristic data CD2, or the third characteristic data CD3 in response to the speed V (or the acceleration a) acquired by the operation parameter acquisition unit 54 (step S72, S73, S74). With this configuration, since the processor 32 can more smoothly change the operation feeling (i.e., light or heavy operation feeling) on the robot 12 felt by the operator, it is possible to improve the operation feeling.

In the present embodiment, a case is described in which the three characteristic data pieces CD1, CD2, and CD3 are pre-stored in the memory 34. However, while one of the characteristic data pieces CD1, CD2, and CD3 is stored in the memory 34, the processor 32 may obtain the other two of the characteristic data pieces CD1, CD2, and CD3 by a predetermined calculation using the one characteristic data CD stored in the memory 34.

For example, it is assumed that the first characteristic data CD1 is pre-stored in the memory 34. In this case, in step S73, the processor 32 may obtain the second characteristic data CD2 by performing a predetermined calculation so as to reduce the slope δα/δFh of the first characteristic data CD1.

Further, in step S74, the processor 32 may obtain the third characteristic data CD3 by performing a predetermined calculation so as to reduce the slope δα/δFh of the first characteristic data CD1 or the second characteristic data CD2. Thus, it is not necessary to store a large amount of characteristic data pieces CDn in the memory 34. Although the three characteristic data pieces CD1, CD2, and CD3 are illustrated in the example illustrated in FIG. 22, two or four or more characteristic data pieces CDn may be stored in the memory 34.

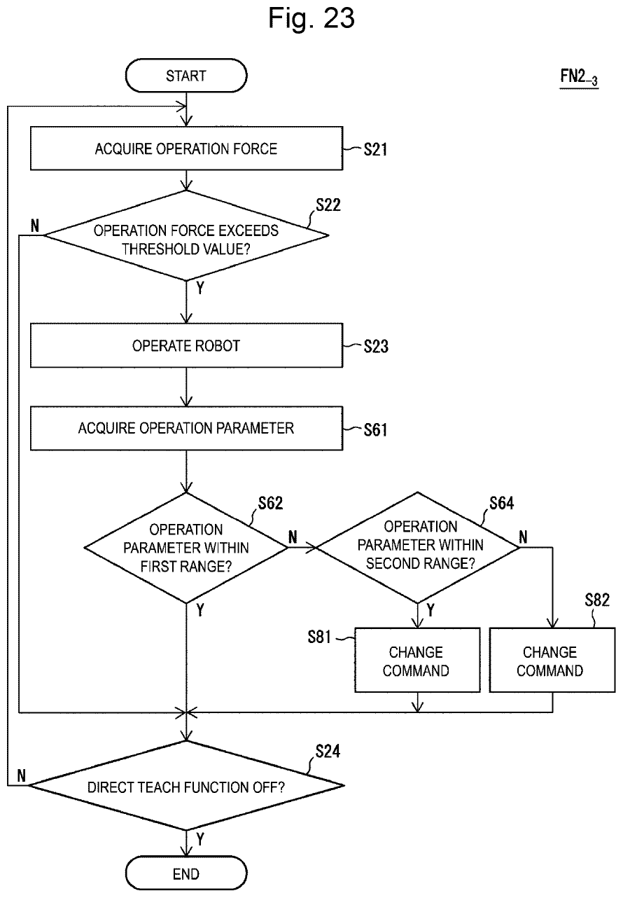

Next, a direct teach function FN2_{_3} according to yet still another embodiment will be described with reference to FIG. 23. The controller 16 illustrated in FIG. 19 executes the flow illustrated in FIG. 23 as the direct teach function FN2_{_3}. Note that in the flow illustrated in FIG. 23, processes similar to those of the flow illustrated in FIG. 20 are assigned identical step numbers, and overlapping descriptions thereof will be omitted.

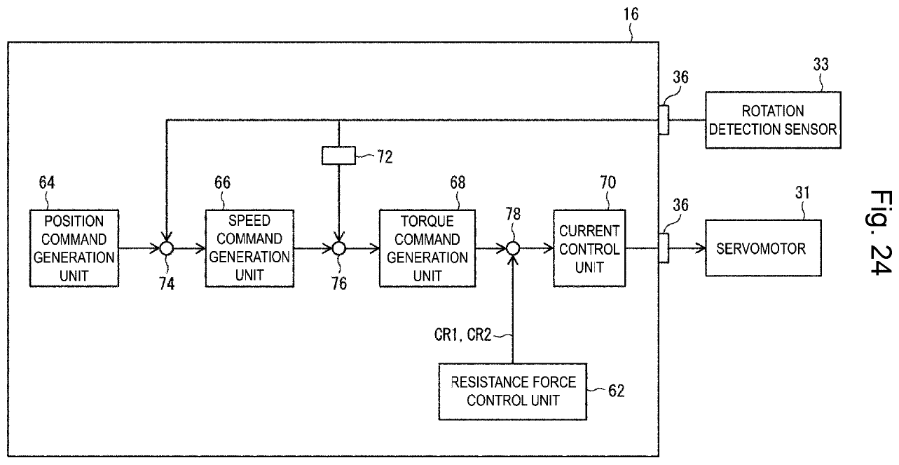

In the flow illustrated in FIG. 23, the processor 32 functions as the direct teach execution unit 52, executes steps S21 to S23. Here, in step S23, the processor 32 generates a command CM for the actuators 31 of the robot 12 in order to operate the robot 12 in accordance with the handling force Fh determined in the most recent step S21. A method of generating the command CM will be described below with reference to FIG. 24.

As illustrated in FIG. 24, the controller 16 includes a position command generation unit 64, a speed command generation unit 66, a torque command generation unit 68, a current control unit 70, a differentiator 72, subtractors 74 and 76, and an adder 78. The processor 32 is in charge of executing calculation processing for implementing functions of the position command generation unit 64, the speed command generation unit 66, the torque command generation unit 68, the current control unit 70, the differentiator 72, the subtractors 74 and 76, and the adder 78.

The position command generation unit 64 generates a position command CM1 that defines the position of the robot 12 (e.g., the end effector 30) and outputs the command to the subtractor 74. The subtractor 74 subtracts the feedback FB (rotational position) supplied from the rotation detection sensor 33 via the I/O interface 36 from the input position command CM1, and outputs the result as a position deviation δp to the speed command generation unit 66.

The speed command generation unit 66 generates a speed command CM2 based on the positional deviation δP and outputs the command to the subtractor 76. On the other hand, the differentiator 72 obtains the speed V by time-differentiating the feedback FB supplied from the rotation detection sensor 33, and outputs the speed V to the subtractor 76 as speed feedback V. The subtractor 76 subtracts the speed feedback V from the input speed command CM2 and outputs the subtraction result to the torque command generation unit 68 as a speed deviation δV.

Subsequently, the torque command generation unit 68 generates a torque command CM3 based on the speed deviation δV. The current control unit 70 generates a voltage signal CM4 (e.g., a PWM control signal) based on the torque command CM3 and transmits the signal to the actuator 31 via the I/O interface 36. The position command CM1, the speed command CM2, the torque command CM3, and the voltage signal CM4 form the command CM to the actuators 31.

Thus, in this step S23, the processor 32 generates the command CM (the position command CM1, the speed command CM2, the torque command CM3, and the voltage signal CM4) for the actuators 31, and operates the robot 12 in accordance with the handling force Fh. Referring back to FIG. 23, upon determining YES in step S62, the processor 32 proceeds to step S24 and determines whether or not the direct teach function FN2_{_3} is disabled.

On the other hand, upon determining YES in step S64, in step S81, the processor 32 functions as the resistance force control unit 62 and changes the command CM generated in step S23. Specifically, as illustrated in FIG. 24, the processor 32 functions as the resistance force control unit 62 to generate a command correction value CR1 and output the value to the adder 78. The command correction value CR1 is used to change the torque command CM3 in order to cause the actuators 31 to generate forces acting in directions opposite to the handling force Fh.

The adder 78 generates a corrected torque command CM3′ by adding the command correction value CR1 generated by the resistance force control unit 62 to the torque command CM3 output from the torque command generation unit 68, and outputs the corrected torque command CM3′ to the current control unit 70. By thus correcting the torque command CM3 with the command correction value CR1, a force opposite to the handling force Fh is generated in each movable component of the robot 12, thereby increasing the resistance force RF against the handling force Fh.

Referring back to FIG. 23, upon determining NO in step S64, in step S82, the processor 32 functions as the resistance force control unit 62 to change the command CM generated in step S23. Specifically, the processor 32 functions as the resistance force control unit 62, generates a command correction value CR2 (FIG. 24), and outputs the value to the adder 78.

This command correction value CR2 is a value different from the command correction value CR1 generated in step S81, and is generated so that a force larger than that with the command correction value CR1 can be generated in a direction opposite to the handling force Fh. The adder 78 generates the corrected torque command CM3′ by adding the command correction value CR2 generated by the resistance force control unit 62 to the torque command CM3, and outputs the corrected torque command CM3′ to the current control unit 70. As a result, the resistance force RF against the handling force Fh can be increased from that in step S81. After step S81 or S82, the processor 32 proceeds to step S24.

As described above, in the present embodiment, the direct teach execution unit 52 generates the command CM (the position command CM1, the speed command CM2, the torque command CM3, and the voltage signal CM4) for the actuators 31 of the robot 12 in order to operate the robot 12 under the direct teach function FN2_{_3}.

Then, the resistance force control unit 62 changes the resistance force RF by changing the command CM (specifically, the torque command CM3) generated by the direct teach execution unit 52 in response to the speed V (or the acceleration a) acquired by the operation parameter acquisition unit 54 (steps S81 and S82). With this configuration, it is possible to swiftly and precisely control the resistance force RF against the handling force Fh.

In the present embodiment, a case is described in which the resistance force control unit 62 corrects the torque command CM3 using the command correction value CR1 or CR2. However, the present disclosure is not limited thereto, and the resistance force control unit 62 may correct the position command CM1, the speed command CM2, or the voltage signal CM4 as long as the resistance force RF against the handling force Fh can be changed.

The flow of the direct teach function FN2_{_1} illustrated in FIG. 20, the direct teach function FN2_{_2} illustrated in FIG. 21, or the direct teach function FN2_{_3} illustrated in FIG. 23 may be applied to the above-described step S3 or S3′. That is, in this case, the controller 16 illustrated in FIG. 2 or 9 further includes the resistance force control unit 62. Upon determining NO in step S64 in FIG. 20, FIG. 21, or FIG. 23, the processor 32 may generate an alarm signal AL3 as an image or a voice indicating “Excessive speed or acceleration. Reduce handling force” and output the signal to the display device 42 or 44 or to a speaker.

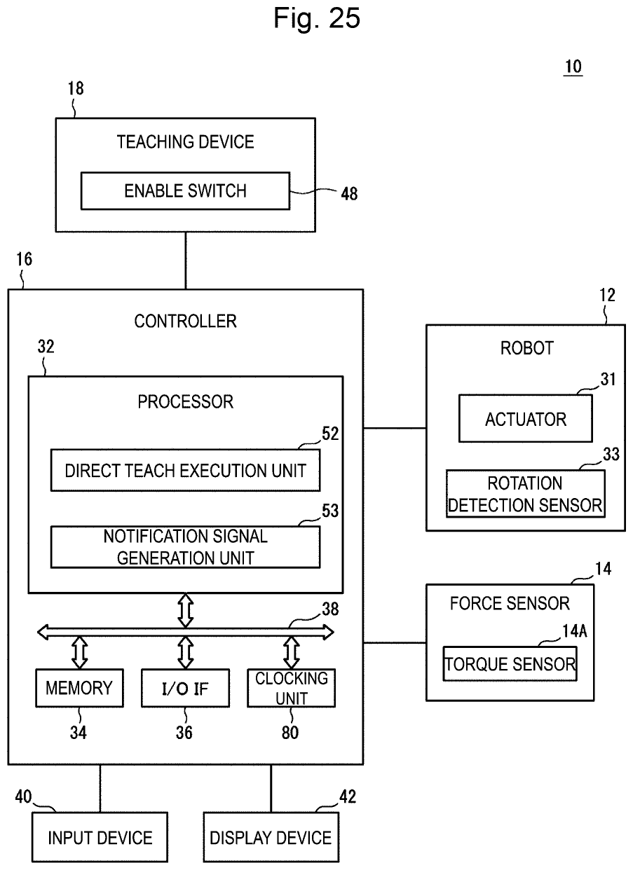

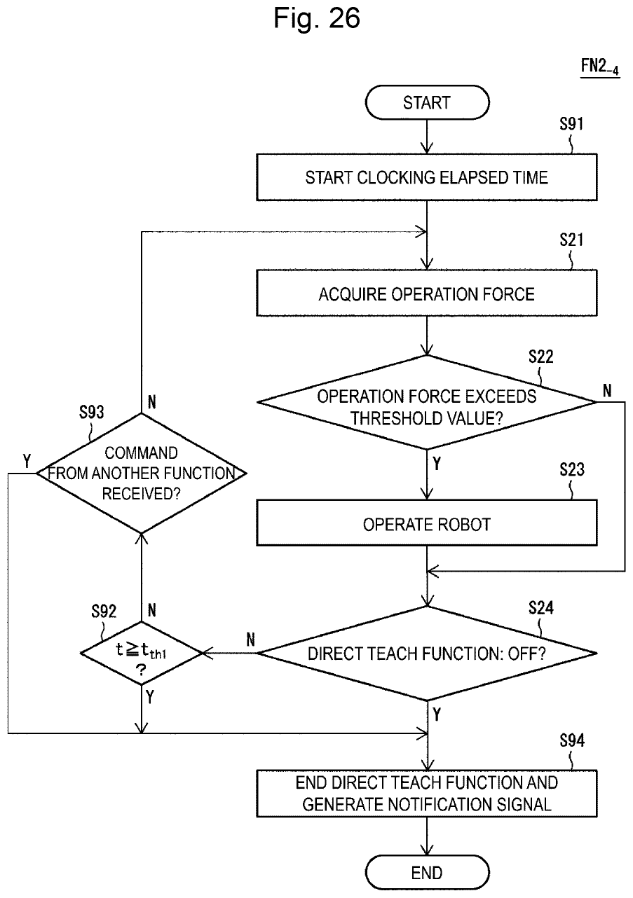

Subsequently, still another function of the robot system 10 will be described with reference to FIG. 25 and FIG. 26. The controller 16 illustrated in FIG. 25 further includes a clocking unit 80. The clocking unit 80 is communicably connected to the processor 32 via the bus 38, and clocks an elapsed time t from a certain time point in response to a command from the controller 16.

The controller 16 illustrated in FIG. 25 executes the flow of a direct teach function FN2_{_4} illustrated in FIG. 26. Note that in the flow illustrated in FIG. 26, processes similar to those of the flow illustrated in FIG. 6 are assigned identical step numbers, and overlapping descriptions thereof will be omitted. The flow illustrated in FIG. 26 starts at a time point t₀ at which the processor 32 receives a command for starting the direct teach function FN2_{_4}.

In step S91, the processor 32 starts clocking the elapsed time t from the time point t₀ at which the processor 32 starts the flow in FIG. 26. Specifically, the processor 32 transmits a time clocking command to the clocking unit 80 at the time point t₀, and the clocking unit 80 starts clocking the elapsed time t from the time point t₀ in response to the time clocking command. Thereafter, the processor 32 functions as the direct teach execution unit 52 to execute steps S21 to 23, and determine whether or not the direct teach function FN2_{_4} is disabled in step S24.

Upon determining NO in step S24, in step S92, the processor 32 determines whether or not the elapsed time t clocked by the clocking unit 80 has exceeded a predetermined threshold value tₜₕ₁ (i.e., t≥tₜₕ₁). The processor 32 proceeds to step S94 upon determining that t≥tₜₕ₁ holds and thus determining YES, and proceeds to step S93 upon determining NO.

In step S93, the processor 32 determines whether or not a command for a function FN other than the direct teach function FN2_{_4} being executed has been received. Here, during the execution of the direct teach function FN2_{_4}, the operator may wish to temporarily halt the operation of applying the handling force Fh to the robot 12 and execute a function FN other than the direct teach function FN2_{_4}, such as the teach function FN3, the automatic operation function FN4, or the operation confirmation function FN5 described above.

As an example, when the processor 32 is executing the direct teach function FN2_{_4} in FIG. 26, the operator operates the input device 46 of the teaching device 18 to input a command CM5 for causing the robot 12 to perform the jogging operation by the teach function FN3 to the teaching device 18. As another example, during execution of the direct teach function FN2_{_4}, the operator operates the input device 46 of the teaching device 18 to input, to the teaching device 18, a command CM6 for causing the robot 12 to execute an automatic operation (or a trial operation) under the automatic operation function FN4 (the operation confirmation function FN5).

As still another example, during execution of the direct teach function FN2_{_4}, the operator operates the input device 46 of the teaching device 18 to input, to the teaching device 18, a command CM7 for causing the display device 44 to display an input image for executing the teach function FN3, the automatic operation function FN4, or the operation confirmation function FN5.

The processor of the teaching device 18 supplies the command CM5, CM6, or CM7 received from the operator to the controller 16. The operator may operate the input device 40 of the controller 16 to directly input the command CM5, CM6, or CM7 for the teach function FN3, the automatic operation function FN4, or the operation confirmation function FN5 to the controller 16.

The processor 32 of the controller 16 determines YES in this step S93 when the controller 16 has received the command CM5, CM6, or CM7 for the teach function FN3, the automatic operation function FN4, or the operation confirmation function FN5, and proceeds to step S94. On the other hand, the processor 32 determines NO and returns to step S21 when the controller 16 has not received the command CM5, CM6, or CM7.

Upon determining YES in step S24, S92, or S93, in step S94, the processor 32 ends the direct teach function FN2_{_4} and generates a notification signal SG indicating the end of the direct teach function FN2_{_4}. For example, the processor 32 may generate the notification signal SG as an image or a voice indicating that “direct teach function is automatically ended” and output the signal to the display device 42 or 44 or to the speaker. As described above, in the present embodiment, the processor 32 functions as a notification signal generation unit 53 (FIG. 25) that generates the notification signal SG. Subsequently, the processor 32 ends the flow in FIG. 26.

Thus, the processor 32 repeatedly executes the loop of steps S21 to S24, S92, and S93 until determining YES in step S24, S92, or S93, and continuously executes the direct teach function FN2_{_4}. In other words, as long as it is determined NO in steps S24, S92, and S93, the processor 32 continues to execute the direct teach function FN2_{_4} until the elapsed time t reaches a threshold value tₜₕ₁ (i.e., over a period tₜₕ₁), and automatically ends the direct teach function FN2_{_4} when the elapsed time t exceeds the threshold value tₜₕ₁ (i.e., when the period tₜₕ₁ elapses).

As described above, in the present embodiment, when the elapsed time t from the time point t₀ at which the command for starting the direct teach function FN2_{_4} is received exceeds the predetermined threshold value tₜₕ₁ (when determined YES in step S92), the direct teach execution unit 52 ends the direct teach function FN2_{_4} (step S94).

Here, after the processor 32 starts the direct teach function FN2_{_4}, the operator may leave a work cell for a long period of time due to various reasons. When a third party accidentally pushes the robot 12 while the operator is absent, the robot 12 may be operated unintentionally under the direct teach function FN2_{_4}.

According to the present embodiment, since the direct teach function FN2_{_4} is automatically ended when the predetermined period tₜₕ₁ elapses after the processor 32 starts the direct teach function FN2_{_4}, it is possible to prevent the unintentional operation of the robot 12 as described above. In addition, in the present embodiment, the controller 16 further includes the clocking unit 80 that clocks the elapsed time t. With this configuration, the processor 32 can reliably clock the elapsed time t without delay.

In addition, in the present embodiment, the direct teach execution unit 52 ends the direct teach function FN2_{_4} upon receiving the command CM5, CM6, or CM7 for the function FN3, FN4, or FN5 other than the direct teach function FN2_{_4} during the execution of the direct teach function_{_4} (when determining YES in step S93) (step S94).

With this configuration, when the operator attempts to interrupt the direct teach function FN2_{_4} and execute, for example, the teach function FN3, the automatic operation function FN4, or the operation confirmation function FN5, the direct teach function FN2_{_4} can be automatically ended and the operation can be smoothly shifted to the teach function FN3, the automatic operation function FN4, or the operation confirmation function FN5.

Then, the processor of the teaching device 18 (or the processor 32 of the controller 16) causes the robot 12 to execute a jog operation, an automatic operation, or a trial operation, or causes the display device 44 to display an input image in response to the command CM5, CM6, or CM7 received from the operator, and receives an input for executing the teach function FN3, the automatic operation function FN4, or the operation confirmation function FN5.

In addition, in the present embodiment, the controller 16 further includes the notification signal generation unit 53 that generates when the direct teach execution unit 52 ends the direct teach function FN2_{_4}, the notification signal SG for notifying the end. With this configuration, the operator can easily recognize that the direct teach function FN2_{_4} has been automatically ended.

In the present embodiment, a case is described in which the time point t₀ described above is the time point at which the command for starting the direct teach function FN2_{_4} is received and the flow of the direct teach function FN2_{_4} illustrated in FIG. 26 starts. However, strictly speaking, there may be a time lag between a time point t_{0_1} at which the command for starting the direct teach function FN2_{_4} is received and a time point t_{0_2} at which the processor 32 receives the command and starts the direct teach function FN2_{_4} in FIG. 26.

In this case, the processor 32 may cause the clocking unit 80 to clock the elapsed time t from the time point t₀ which is any of the time point t_{0_1} and the time point t_{0_2}. That is, in this case, the processor 32 functions as the direct teach execution unit 52, and ends the direct teach function FN2_{_4} when the elapsed time t from the time point t_{0_1} or t_{0_2} exceeds a predetermined threshold value tₜₕ₁.

Note that the clocking unit 80 may be omitted from the controller 16 and an external device may be requested to provide the function of the clocking unit 80. For example, an electronic timepiece provided outside the controller 16 (or a clocking unit incorporated in another computer) may be connected to the I/O interface 36 of the controller 16, and the processor 32 may acquire the elapsed time t described above with reference to the time clocked by the electronic timepiece.

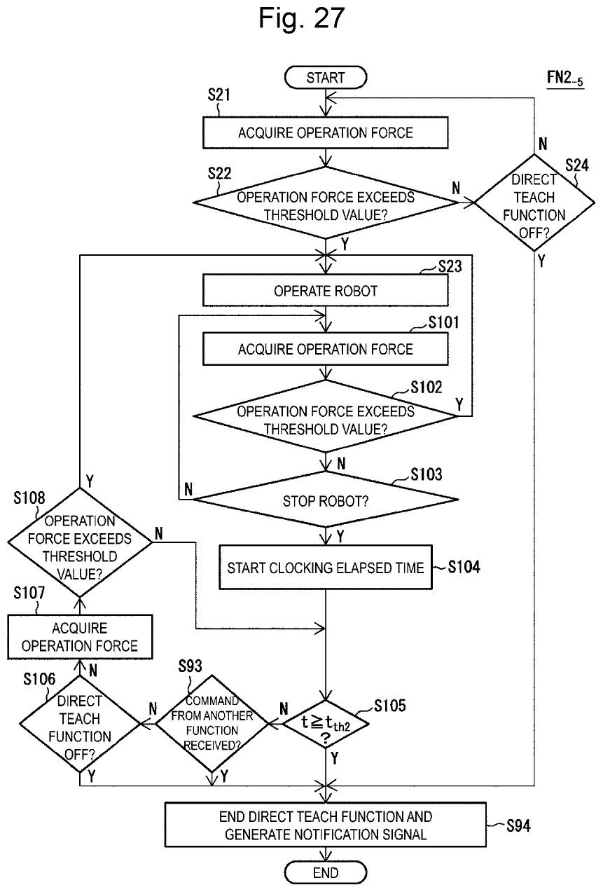

Next, still another direct teach function FN2_{_5} will be described with reference to FIG. 27. The controller 16 illustrated in FIG. 25 executes the flow illustrated in FIG. 27 as the direct teach function FN2_{_5}. Note that in the flow illustrated in FIG. 27, processes similar to those of the flow illustrated in FIG. 26 are assigned identical step numbers, and overlapping descriptions thereof will be omitted.

After the start of the flow in FIG. 27, the processor 32 functions as the direct teach execution unit 52 to execute steps S21 to S23, and determines whether or not the direct teach function FN2_{_5} is disabled in step S24. After step S23, in step S101, the processor 32 acquires the handling force Fh as in step S21 described above.

In step S102, the processor 32 determines whether or not the magnitude of the handling force Fh acquired in the most recent step S101 exceeds the predetermined threshold value Fhₜₕ as in step S22 described above. The processor 32 returns to step S23 upon determining YES, and proceeds to step S103 upon determining NO.

In step S103, the processor 32 determines whether or not the operation of the robot 12 has stopped. Here, when the operator releases the handling force Fh to the robot 12, the robot 12 automatically stops. For example, the processor 32 can determine whether or not the operation of the robot 12 has stopped, based on the feedback FB from the rotation detection sensor 33. The processor 32 proceeds to step S104 upon determining that the operation of the robot 12 has stopped (i.e., YES), and returns to step S101 upon determining NO.

In step S104, the processor 32 starts clocking the elapsed time t from the time point t₁ at which YES is determined in step S103 (i.e., the time point at which the robot is stopped). Specifically, the processor 32 transmit a time clocking command to the clocking unit 80 at the time point t₁, and the clocking unit 80 starts clocking the elapsed time t from the time point t₁ in response to the time clocking command.

In step S105, the processor 32 determines whether or not the elapsed time t clocked by the clocking unit 80 has exceeded a predetermined threshold value tₜₕ₂ (i.e., t≥tₜₕ₂). The predetermined threshold value tₜₕ₂ may be set to be a time shorter (or longer) than the predetermined threshold value tₜₕ₁ described above. The processor 32 proceeds to step S94 upon determining that t≥tₜₕ₂ holds and thus determining YES, and proceeds to step S93 upon determining NO.

Upon determining NO in step S105, the processor 32 executes the above-described step S93, and determines whether or not the processor 32 has received a command (e.g., the above-described command CM5, CM6, or CM7) for a function FN (e.g., the teach function FN3, the automatic operation function FN4, or the operation confirmation function FN5) other than the direct teach function FN2_{_5} which is being executed. The processor 32 proceeds to step S94 upon determining YES, and proceeds to step S106 upon determining NO.

In step S106, as in step S24, the processor 32 determines whether or not the direct teach function FN2_{_5} is disabled, proceeds to step S94 upon determining YES, and proceeds to step S107 upon determining NO.

In step S107, the processor 32 acquires the handling force Fh as in step S21 described above. In step S108, the processor 32 determines whether or not the magnitude of the handling force Fh acquired in the most recent step S107 exceeds the predetermined threshold value Fhₜₕ as in step S22 described above. The processor 32 returns to step S23 upon determining YES, and returns to step S105 upon determining NO.

On the other hand, upon determining YES in step S105, S93 or S106, the processor 32 executes the above-described step S94, ends the direct teach function FN2_{_5} in FIG. 27, and generates the notification signal SG indicating the end of the direct teach function FN2_{_5}. Subsequently, the processor 32 ends the flow in FIG. 27.

As described above, upon determining YES in step S103 (i.e., the robot 12 is stopped), the processor 32 repeatedly executes a loop of steps S105, S93, and S106 to S108, as long as it is determined NO in steps S105, S93, S106, and S108. Then, when the elapsed time t from the time point t₁ at which it is determined YES in step S103 exceeds the threshold value tₜₕ₂ (when the period tₜₕ₂ elapses), the processor 32 automatically ends the direct teach function FN2_{_5} in step S94.

As described above, in the present embodiment, the direct teach execution unit 52 ends the direct teach function FN2_{_5}, when the elapsed time t from the time point t₁ at which the robot 12 operated by the direct teach function FN2_{_5} is stopped (i.e., the time point at which it is determined YES in step S103) exceeds the predetermined threshold value tₜₕ₂. With this configuration, when the operator is absent during the execution of the direct teach function FN2_{_5}, it is possible to prevent the robot 12 from being unintentionally operated by being accidentally pushed by a third party.

The flow of the direct teach function FN2_{_4} illustrated in FIG. 26 or the direct teach function FN2_{_5} illustrated in FIG. 27 may be applied to the above-described step S3 or S3′. That is, in this case, the controller 16 illustrated in FIG. 2 or 9 further includes the clocking unit 80.

For example, when the direct teach function FN2_{_4} illustrated in FIG. 26 is applied to step S3, the time point t₀ at which the processor 32 starts the flow in FIG. 26 is the time point at which the above-described direct teach function start command is received (i.e., the time point at which it is determined YES is in step S1). When the direct teach function FN2_{_4} illustrated in FIG. 26 is applied to step S3′, the time point t₀ at which the flow in FIG. 26 starts is the time point at which the enable switch ON signal is received (i.e., the time point at which it is determined YES in step S31 or S34 described above).

Furthermore, step S93 may be omitted from the flow in FIG. 26 or FIG. 27. In step S94 in FIG. 26 or 27, the processor 32 may end the direct teach function FN2_{_4} or FN2_{_5}, without generating the notification signal SG. That is, in this case, the notification signal generation unit 53 can be omitted from the controller 16 illustrated in FIG. 25.

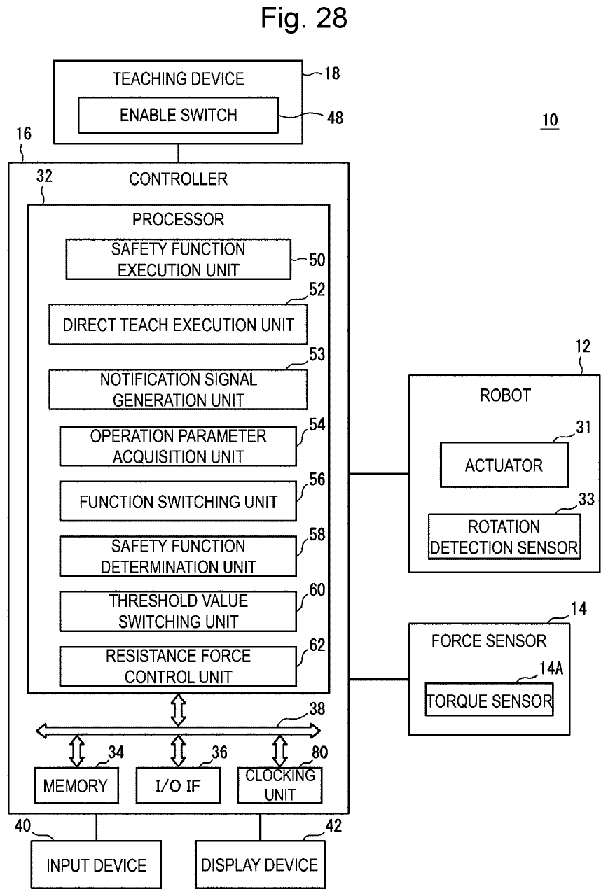

It should be noted that the functions of the controller 16 illustrated in FIG. 2, FIG. 9, FIG. 19, and FIG. 25 can be combined with each other. Such an embodiment is illustrated in FIG. 28. The controller 16 illustrated in FIG. 28 includes the safety function execution unit 50, the direct teach execution unit 52, the operation parameter acquisition unit 54, the function switching unit 56, the safety function determination unit 58, the threshold value switching unit 60, the resistance force control unit 62, and the clocking unit 80, and selectively executes the flows in FIG. 3, FIG. 5 to FIG. 8, FIG. 11 to FIG. 13, FIG. 18, FIG. 20, FIG. 21, FIG. 23, FIG. 26, and FIG. 27.

In addition, the flows in FIG. 3, FIG. 5 to FIG. 8, FIG. 11 to FIG. 13, FIG. 18, FIG. 20, FIG. 21, FIG. 23, FIG. 26, and FIG. 27 may be combined. For example, by executing steps S61 to S66 in FIG. 20 after step S23 in FIG. 27, the steps can be combined with the flow in FIG. 27. The flows illustrated in FIG. 21 and FIG. 23 can be similarly combined with the flow illustrated in FIG. 27. Note that the flows in FIG. 3, FIG. 5 to FIG. 8, FIG. 11 to FIG. 13, FIG. 18, FIG. 20, FIG. 21, FIG. 23, FIG. 26, and FIG. 27 are examples, and the processes of these flows may be appropriately changed or deleted, or any other processes may be added.

The processor 32 may execute the flows in FIG. 3, FIG. 5 to FIG. 8, FIG. 11 to FIG. 13, FIG. 18, FIG. 20, FIG. 21, FIG. 23, FIG. 26, and FIG. 27 in accordance with the computer program PG2. This computer program PG2 may be pre-stored in the memory 34. The functions of the safety function execution unit 50, the direct teach execution unit 52, the operation parameter acquisition unit 54, the function switching unit 56, the safety function determination unit 58, the threshold value switching unit 60, and the resistance force control unit 62 executed by the processor 32 may be functional modules implemented by the computer program PG.

Further, the robot 12 is not limited to being the vertical articulated robot, and may be any other type of robot, such as a horizontal articulated robot, a parallel link robot, or the like for example. Although the present disclosure has been described through embodiments above, the embodiments described above do not limit the scope of the invention claimed in the claims.

### REFERENCE SIGNS LIST

10 Robot system
12 Robot
14 Force sensor
14A Torque sensor
14B Force detection sensor
16 Controller
18 Teaching device
34 Memory
50 Safety function execution unit
52 Direct teach execution unit
54 Operation parameter acquisition unit
56 Function switching unit
58 Safety function determination unit
60 Threshold switching unit
62 Resistance force control unit

1.-19. (canceled)

20. A controller configured to control an operation of a robot, the controller comprising:
a safety function execution unit configured to execute a safety function of monitoring at least one of a contact force applied to the robot in operation, a speed of the robot, and an acceleration of the robot, and stopping the operation of the robot when the at least one of the contact force, the speed and the acceleration exceeds a predetermined threshold value; and
a direct teach execution unit configured to execute a direct teach function of operating the robot in accordance with a handling force applied to the robot, in parallel with the safety function executed by the safety function execution unit.

21. A controller configured to control an operation of a robot, the controller comprising:
a safety function execution unit configured to execute a safety function of monitoring at least one of a contact force applied to the robot in operation, a speed of the robot, and an acceleration of the robot, and stopping the operation of the robot based on the at least one of the contact force, the speed and the acceleration;
a direct teach execution unit configured to execute a direct teach function of operating the robot in accordance with a handling force applied to the robot; and
a function switching unit configured to switch the safety function by the safety function execution unit between enabled and disabled,
wherein the direct teach execution unit does not execute the direct teach function when the safety function is disabled.

22. The controller of claim 21, wherein the safety function execution unit executes the safety function when the at least one of the contact force, the speed and the acceleration exceeds a predetermined threshold value.

23. The controller of claim 21, further comprising a safety function determination unit configured to determine whether the safety function is enabled or disabled, when the direct teach execution unit executes the direct teach function.

24. The controller of claim 20, wherein the robot is provided with a force sensor configured to detect an external force applied to the robot, and
wherein the safety function execution unit and the direct teach execution unit execute the safety function and the direct teach function respectively, based on detection data of the common force sensor.

25. The controller of claim 20, wherein the robot is provided with a force sensor configured to detect an external force applied to the robot, the force sensor including two-lines detection parts both detecting a force in one direction,
wherein the safety function execution unit executes, in parallel:
a first safety function of monitoring a first contact force obtained based on detection data of one of the two-lines detection parts; and
a second safety function of monitoring a second contact force obtained based on detection data of the other one of the two-lines detection parts, and
wherein the direct teach execution unit obtains the handling force based on the detection data of at least one of the two-lines detection parts in the direct teach function.

26. The controller of claim 20, further comprising a threshold value switching unit configured to switch the threshold value between a first threshold value and a second threshold value larger than the first threshold value,
wherein the threshold value switching unit switches the threshold value from the first threshold value to the second threshold value, when the direct teach execution unit starts the direct teach function or when the at least one of the contact force, the speed and the acceleration exceeds a third threshold value during execution of the direct teach function.

27. A robot system comprising:
a robot; and
the controller of claim 20 configured to control the robot.

28. A method of controlling an operation of a robot, the method comprising:
executing, by a processor, a safety function of monitoring at least one of a contact force applied to the robot in operation, a speed of the robot, and an acceleration of the robot, and stopping the operation of the robot when the at least one of the contact force, the speed and the acceleration exceeds a predetermined threshold value; and
executing, by the processor, a direct teach function of operating the robot in accordance with a handling force applied to the robot, in parallel with the safety function.
